(19) United States
(12) Patent Application Publication
(10) Pub. No.: US 2024/0073489 A1
(43) Pub. Date: Feb. 29, 2024

(54) Mesh Network for Propagating Multi-dimensional World State Data

(71) Applicant: Meta Platforms Technologies, LLC, Menlo Park, CA (US)

(72) Inventor: Alexander Irvin HOPMANN, Seattle, WA (US)

(21) Appl. No.: 17/898,048

(22) Filed: Aug. 29, 2022

(51) Int. Cl. H04N 21/81; H04N 21/8545

(52) U.S. Cl. CPC H04N 21/816; H04N 21/8545; H04L 67/12

(57) ABSTRACT

Aspects of the present disclosure are directed to propagating multi-dimensional world state data between nodes of a mesh network and from the mesh network to client systems by applying multiple levels of filters. World state data can represent state data for entities within a shared software application environment. Implementations of the mesh network can propagate world state data by applying first level server node filtration for the server nodes of the mesh network and second level client specific filtration for client systems connected to the mesh network. In some implementations, an additional level of filtration and/or aggregation is applied by aggregation nodes of the mesh network that source world state data from the server nodes. In some implementations, the server filters and client specific filters can be defined as dimensions and dimension values, where the filter scopes correspond to topologies of the multi-dimensional world state data.

### CROSS-REFERENCE TO RELATED APPLICATION(S)

This application is related to U.S. patent application Ser. No. ______, filed Aug. 29, 2022, having Attorney Docket No. 3589-0157US01 titled “A Mesh Network for Propagating Multi-dimensional World State Data,” which is hereby incorporated by reference in its entirety.

### TECHNICAL FIELD

The present disclosure is directed to propagating multi-dimensional world state data between nodes of a mesh network and from the mesh network to client systems by applying multiple levels of filters.

### BACKGROUND

Shared software application environments, such as artificial reality environments, have grown in popularity, and as adoption and usage accelerates, scale challenges persist and even grow larger. Shared software application environments that generate a high-definition user presence responsive to user movements, such as an avatar, hologram presence, etc., can simulate detailed interactions among different virtual entities (e.g., user avatars, virtual objects, etc.). However, such simulations require high degrees of information sharing (e.g., propagation of world state data) and latency levels that permit real-time responsiveness. In addition, unlike a physical space, the number of users that a software application environment can host is only limited by computing resources and/or system constraints. A high number of users coupled with sophisticated virtual entity interactions can generate volumes of world data that need to be shared among various system components (e.g., client devices, simulation servers, etc.). Conventional systems, such as gaming servers, are often throttled by number of users, the sophistication of virtual entity interactions, and/or hosted virtual environment size. For example, these systems can create seams between software application environments, generate copies of software application environments that limit user experience, or implement other user experience limitations to maintain manageable system constraints.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a diagram illustrating system components to propagate multi-dimensional world state data from a mesh network to client systems by applying multiple levels of filters.

FIG. 6 is a diagram illustrating multiple levels of filters that are applied to world state data.

FIG. 7A is a diagram illustrating server nodes, fabric nodes, and client systems that are used to propagate world state data.

FIG. 7B is a diagram illustrating filters applied to world state data between server nodes and a simulation server.

FIG. 7C is a diagram illustrating filters applied to world state data between server nodes and client systems.

FIG. 7D is a diagram illustrating server nodes, aggregation nodes, fabric nodes, and client systems that are used to propagate world state data.

FIG. 8A is a diagram illustrating defined filters for two server nodes and their corresponding scopes.

FIG. 8B is a diagram illustrating defined filters for three server nodes and their corresponding scopes.

FIG. 8C is a diagram illustrating defined filters for two server nodes an aggregation node and their corresponding scopes.

FIG. 9 is a diagram illustrating a simulation domain and a replication domain for a simulation server.

FIG. 10 a diagram illustrating an entity schema.

FIG. 11 is a flow diagram illustrating a process used in some implementations of the present technology for establishing a connection between a client system and a mesh network using one or more fabric nodes.

FIG. 12 is a flow diagram illustrating a process used in some implementations of the present technology for propagating multi-dimensional world state data from a mesh network to client systems by applying multiple levels of filters.

FIG. 13 is a flow diagram illustrating a process used in some implementations of the present technology for managing nodes of the mesh network.

FIG. 14 is a flow diagram illustrating a process used in some implementations of the present technology for managing filtered data received and displayed at a client system.

FIG. 15 is a flow diagram illustrating a process used in some implementations of the present technology for adjusting a scope of one or more client filters.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to propagating multi-dimensional world state data between nodes of a mesh network and from the mesh network to client systems by applying multiple levels of filters. Using multi-level filtration, implementations maintain manageable world state data responsibilities for mesh network components and propagate tailored world state data to client systems to mitigate against data overflow. World state data can represent state data for a software application environment (e.g., a two-dimensional software environment, a three-dimensional software environment, a XR environment, an immersive environment, etc.), such as states for entities within the software application environment. Example entities include a presence for user(s) participating in the software application environment (e.g., avatar(s)), virtual objects (e.g., non-player entities, objects capable of state changes, etc.), or any other suitable entities. Implementations of the mesh network can propagate world state data by applying at least a first level of server node filtration for the server nodes of the mesh network and at least a second level of client specific filtration for client systems connected to the mesh network. In some embodiments, an additional level of filtration and/or aggregation is applied by aggregation nodes of the mesh network that source world state data from server nodes and propagate the sourced world state data to client systems by applying client specific filtration.

In some implementations, server nodes of the mesh network can receive filtered world state data from one or more simulation servers. For example, simulation servers can perform software application environment processing (e.g., game server simulations) that generates world state data for the software application, such as updated entity locations, actions, poses, and the like. This world state data can be considered transient because simulation servers can, as time progresses, perform additional software application environment processing that generates new (e.g., updated) world state data.

In some implementations, the world state data generated by simulation servers and propagated through the mesh network can be multi-dimensional entity state data. Entities can be a user presence and/or objects in a software application environment. Each entity can comprise a number of property dimensions, such as a string of alphanumeric characters, a multi-dimensional array of numerical values, or any other suitable data. The entity state data propagated through the mesh network can be the entity property dimensions and property dimension values. Example property dimensions for entity state data include one or more of: software application instance identifiers, software application environment locations (e.g., three-dimensional vector that represents an entity's location in an artificial reality environment instance), social graph metrics (e.g., for user presence entities with a representation within a social graph), real-world connection locations (e.g., real-world location from which a client system associated with a user entity connects to the mesh network), any other suitable property dimensions, or any combination thereof.

In some implementations, fabric nodes of the mesh network can manage filters for the server nodes. For example, the multi-dimensional world state data propagated through the mesh network can be portioned across a pool of server nodes using the filters assigned by the fabric nodes. In a simplified example, a first server node can be portioned a first three-dimensional volume of an artificial reality environment and a second server node can be portioned a second three-dimensional volume of the artificial reality environment. In this example, the fabric nodes can assign a first filter to the first server node with defined data values of the artificial reality environment location dimension that correspond to the first three-dimensional volume and a second filter to the second server node with defined data values of the artificial reality environment location dimension that correspond to the second three-dimensional volume. World state data from the simulation servers can then be selectively filtered by the defined first and second filters to portion the world state data across the first and second server nodes. In other examples, the first and second filters can be defined by data values for a plurality of the world state data dimensions such that a topology of the multi-dimensional world state data is apportioned to each of the first and second server nodes.

In some implementations, client specific filters (“client filters”) can be defined by client systems and transmitted to the server nodes/aggregation nodes connected to the client systems. For example, client filters can define world state data dimensions and data values that bound these dimensions which represent a topology of the multi-dimensional world state data. Example world state data dimensions for a defined client filter include location within the software application environment, social graph metric, application specific dimension(s) (e.g., application specific class or group, etc.), proximity to user location within the software application environment, other suitable world state data dimensions, or any combination thereof. In some embodiments, the definition for a first filter parameter for client filter can define a first refresh rate while the definition for a second filter parameter for the client filter can define a second refresh rate. For example, the first refresh rate can be a higher frequency than the second refresh rate. In this example, the server node/aggregation node that applies such a client filter to world state data can provide, to the client system, updated world state data filtered according to the first parameter at the first refresh rate and updated world state data filtered according to the second parameter at the second refresh rate.

In some embodiments, a node manager can monitor a load on server nodes of the mesh network. For example, when the monitored load metric(s) for at least one server node meets a split criteria, the node manager can cause the initiation of a new server node (e.g., trigger the split of an existing server node). In another example, when the monitored load metric(s) for multiple server nodes meets an aggregation criteria, the node manager can cause the initiation of an aggregation node. Example monitored load metrics can include a number of client system connections for the server node(s), a volume of world state data received by/managed at the server node(s) (e.g., covered by a filter assigned to the server node(s)), a computing resource utilization metric (e.g., processors utilization, memory utilization, etc.), or any other suitable load metric. In some implementations, the node manager functionality can be achieved by one or more fabric nodes. In this example, fabric node(s) can manage filter assignments for components of the mesh network, server nodes splitting, aggregation node life cycles, and other suitable mesh network responsibilities.

In some implementations, a server node that provides client filtered world state data to a client system can implement an overflow criteria that further filters the client filtered world state data. For example, client filtered world state data can comprise world state data for a set of entities that meet the defined client filter. In some implementations, the number of entities within the client filtered world state data can be compared to an overflow criteria (e.g., threshold number of entities). When the number of entities meets or exceeds the threshold number of entities, it can be determined that the client filtered world state data meets the overflow criteria. In response, the server node can further filter the client filtered world state data, for example based on a predetermined dimension property for the defined client filter.

In some implementations, a dimension property of a client filter selected for overflow filtering can be predetermined for a given software application environment, such as a shared artificial reality environment. The predetermined dimension property can be the software application environment location, the real-world connection location for client systems (e.g., geographic location), an application specific filter property dimension (e.g., assigned group or class, or other suitable application specific dimension), or any other suitable filter property dimension. In some implementations, the predetermined dimension property can be reduced by a predetermined scope to apply the overflow criteria. For example, the client filter can comprise data values for the dimension property, and the data values (e.g., artificial reality environment volume) can be reduced by a predetermined scope to apply the overflow criteria. The reduced scope client filter can be applied to the client filtered world state data to reduce the number of entities.

In some implementations, the filtered world state data provided to the client system can be the world state data filtered using the reduced scope client filter to reduce the number of entities. The server node can also transmit an indication to the client system that an overflow criteria was triggered at the server node when applying the client system's client filter. When overflow trigger indication(s) are received from a server node, the client system can adjust the client specific filter defined for the server node. In some implementations, a scope for the server node's client filter can be reduced. The scope reduction can be one or more of reducing the software application environment covered by the client filter (e.g., artificial reality environment volume), reducing the social graph coverage (e.g., reducing a scope of a proximity metric) covered by the client filter, reducing dimension data values for an application specific dimension, any other suitable scope reduction, or any combination thereof.

A software application environment data sharing system that can scale along with usage, implement high fidelity virtual entity interactions, and/or host large scale software application environments, such as artificial reality environments, all while continuously sharing world state data across the system, can substantially improve upon conventional techniques.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional systems that implement a software application environment, such as a shared XR environment, suffer from significant drawbacks. For example, conventional systems, such as gaming server networks, are often limited to a maximum number of users, limited by the sophistication of virtual entity interactions, and/or have a maximum hosted virtual environment size. For example, many conventional gaming networks partition software application environments into environment instances hosted by one or more servers, where users only share the software application environment with other users within their environment instance. Other conventional gaming networks create seams that partition a software application environment into sub-environments. Rather than implementing a large scale software application environment, these seams generate isolated sub-environments that limit the interactions available for users between sub-environments. In addition, some conventional gaming networks implement low fidelity or limited entity interactions to limit the volume of world state data generated for a software application environment.

In general, these conventional gaming networks place constraints on a software application environment, such as scale constraints for users, scale constraints for environment size, and/or constraints on the fidelity of environment entity interactions. On the other hand, implementations of the mesh network disclosed herein can effectively scale with increases in user participation and/or environment size, and support high fidelity entity interactions. The architecture of the mesh network and the propagation of world state data via the architecture, such as the multi-level filtering performed by client nodes and/or aggregation nodes, generates a dynamic design that does not require constraining the environment in the manner that conventional gaming networks require.

For example, the management of client server node filters, by implementations of one or more fabric nodes, can apportion the responsibilities of software application environment world state data sharing across a pool of scalable nodes. In addition, scope difference between client filters and server node filters decouples these components so that the server nodes can be efficiently organized/apportioned world state data without the burden of precisely fitting one or more client systems. For example, a client system can establish multiple connections with multiple server nodes/aggregation nodes to satisfy the world state data requests of the client. Reducing the rigid structures that bind servers to clients in conventional architectures frees implementations to scale in dynamic ways. In some implementations, the functionality to monitor server nodes and, in response to the monitoring, scale server nodes, replicate server nodes, split server nodes, and/or aggregate data from server nodes, provides a dynamic solution to the scale problems presented by software application environment with many participating users, such as shared XR environments.

Implementations also offload, from simulation servers, client connection management and world state data transmissions to client systems. For example, lightweight and easily scalable server nodes/aggregation nodes can absorb these responsibilities so that the architecture can scale lightweight components (e.g., server nodes/aggregation nodes) independently from more robust components (e.g., simulation servers). In addition, because server nodes and aggregation nodes are lightweight, replication and fault recovery are simplified in implementations of the mesh network.

In some implementations, server nodes and/or aggregation nodes can be implemented at an edge computing device as opposed to a data center. For example, communication between a client system and a device resident at a data center may experience a first latency. On the other hand, an edge computing device can be located closer to the client system (e.g., not at a data center), and thus communication between the client system and the edge computing device can experience a latency that is less than the first latency. Because server nodes and/or aggregation nodes can be implemented as lightweight components, they can be readily provisioned at edge computing devices to achieve low latency communications with client systems.

In some implementations, server nodes and aggregation nodes propagate world state data as blobs of entity state data. For example, while client systems and/or simulation servers can serialize the world state data to update a stored local state for entities, the server nodes and aggregation nodes can propagate the world state data without serializing and/or updating local entity states. In order to perform filtering on the world state data, implementations of server nodes and aggregation nodes can selectively access predefined locations of the world state data (e.g., predetermined memory locations of a predefined entity schema) to retrieve world state data dimensional values (e.g., on which filtering can be performed). This lightweight approach to propagating world state data leads to decreased latency for client communications and reduces the complexity of the server nodes/aggregation nodes, leading to increased scalability and flexibility.

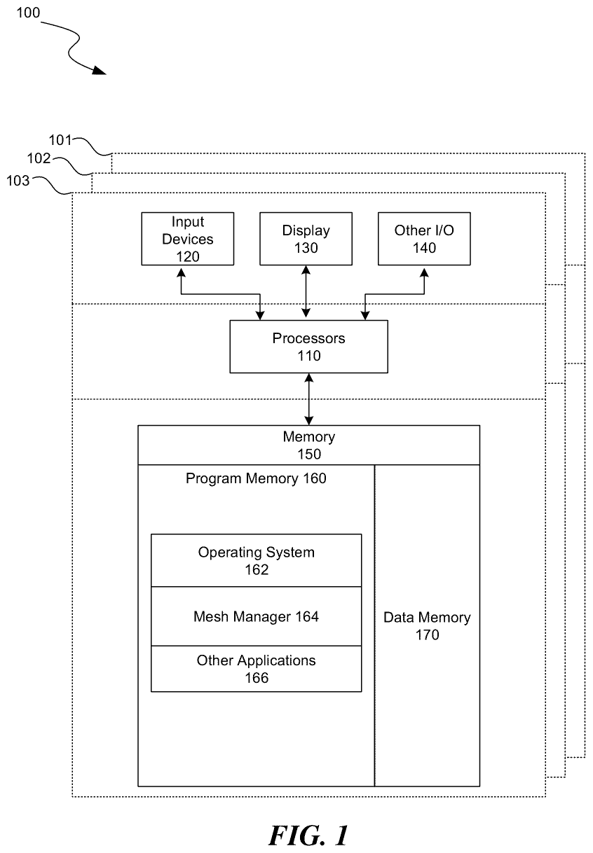

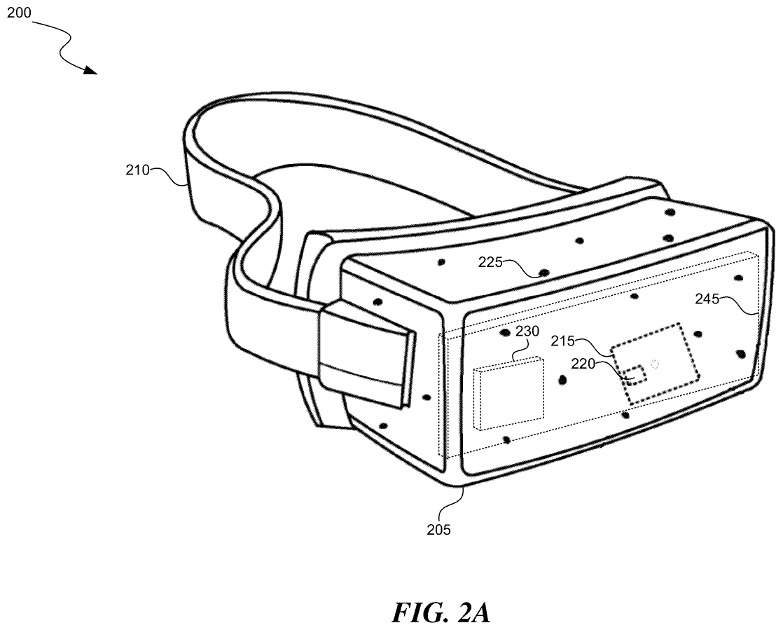

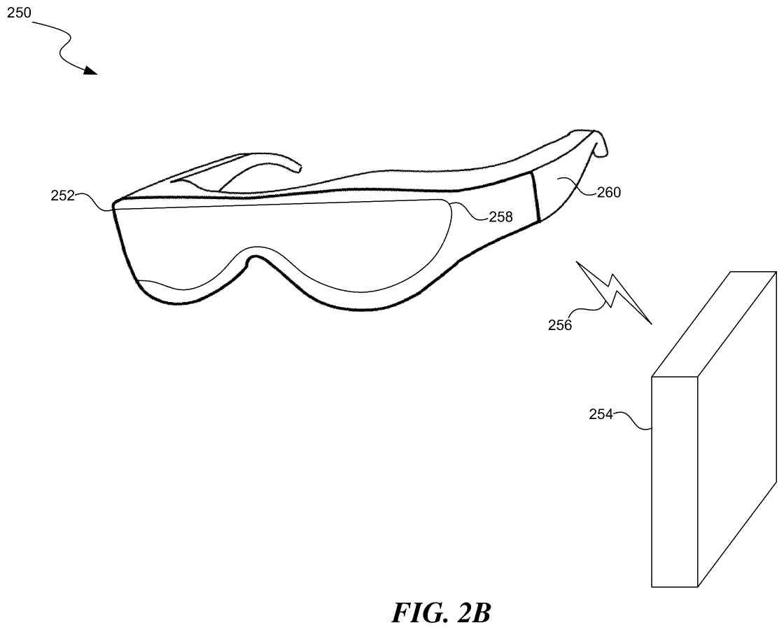

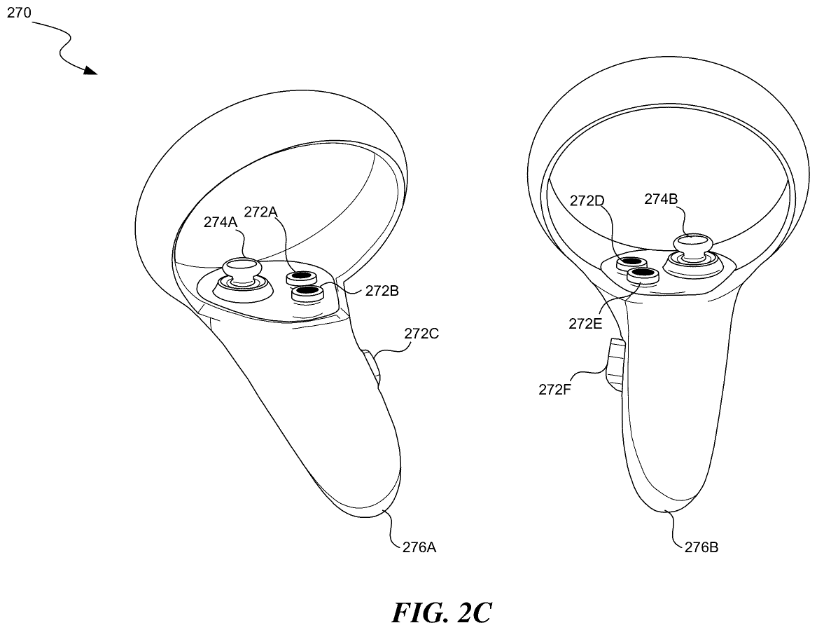

Several implementations are discussed below in more detail in reference to the figures. FIG. 1 is a block diagram illustrating an overview of devices on which some implementations of the disclosed technology can operate. The devices can comprise hardware components of a computing system 100 that propagate multi-dimensional world state data between nodes of a mesh network and from the mesh network to client systems by applying multiple levels of filters. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, mesh manager 164, and other application programs 166. Memory 150 can also include data memory 170 that can include, e.g., world state data, entity information, filter definitions, thresholds or criteria, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

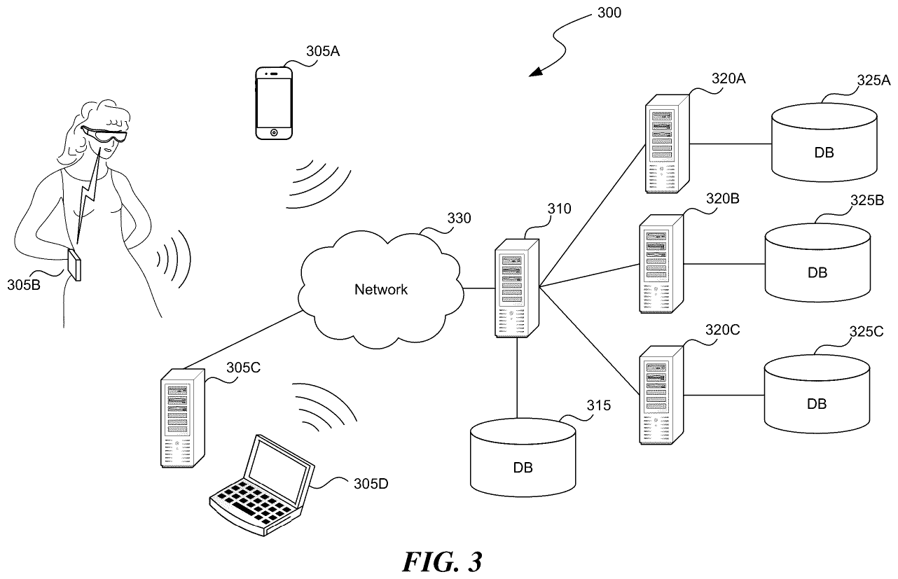

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the users node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

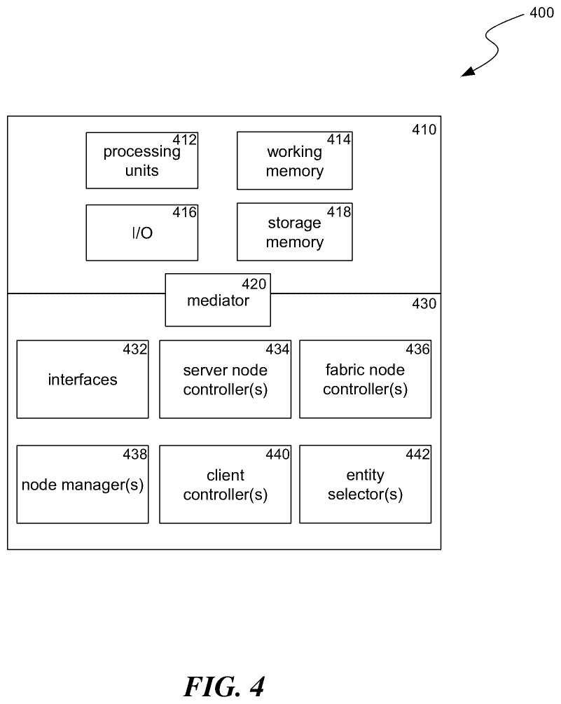

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for propagating multi-dimensional world state data from a mesh network to client systems by applying multiple levels of filters. Specialized components 430 can include server node controller 434, fabric node controller 436, node manager 438, filter assignment manager 440, entity storage controller 442, client controller 444, entity selector 446, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

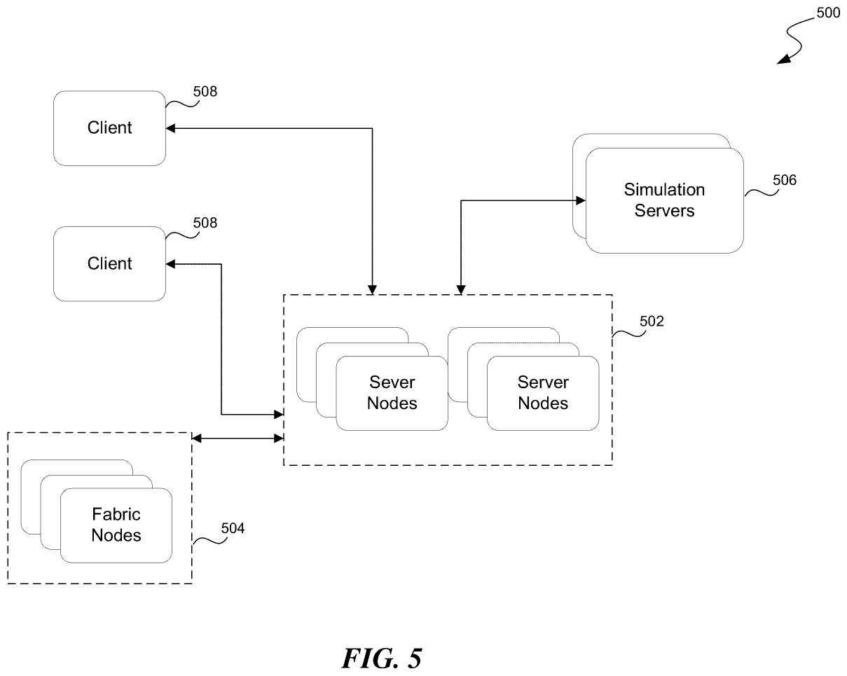

Server node controller(s) 434 can operate functionality for one or more server nodes of the mesh network. For example, server node controller(s) 434 can store and/or apply defined server node filters (e.g., defined for the server node), client specific filters (e.g., defined for each connected client), and simulation server filters (e.g., defined for each connected simulation server). In some implementations, server node filter(s) and simulation server filter(s) can be defined by fabric node controller(s) 436. In some implementations, these filters can define dimension properties and dimension data values for these dimension properties that correspond to topologies of multi-dimensional world state data. Descriptions with references to FIGS. 5, 6, 7A, 7B, 7C, 7D, 10, and 11-14 further describe the functionality of server node controller(s) 434.

Fabric node controller(s) 436 can operate functionality for one or more fabric node nodes of the mesh network. For example, fabric node controller(s) 436 can define and adjust filters for components of the mesh network, such as server nodes, aggregation nodes, and/or simulation servers. In some implementation, fabric node controller(s) can also match client requested world state data (e.g., comprising a requested topology of multi-dimensional world state data, or a defined filter) to server nodes/aggregation nodes that comprise a coverage satisfying the client requests. Descriptions with references to FIGS. 5, 6, 7A, 7B, 7C, 7D, 8A, 8B, 8C, 10, and 11-14 further describe the functionality of fabric node controller(s) 436.

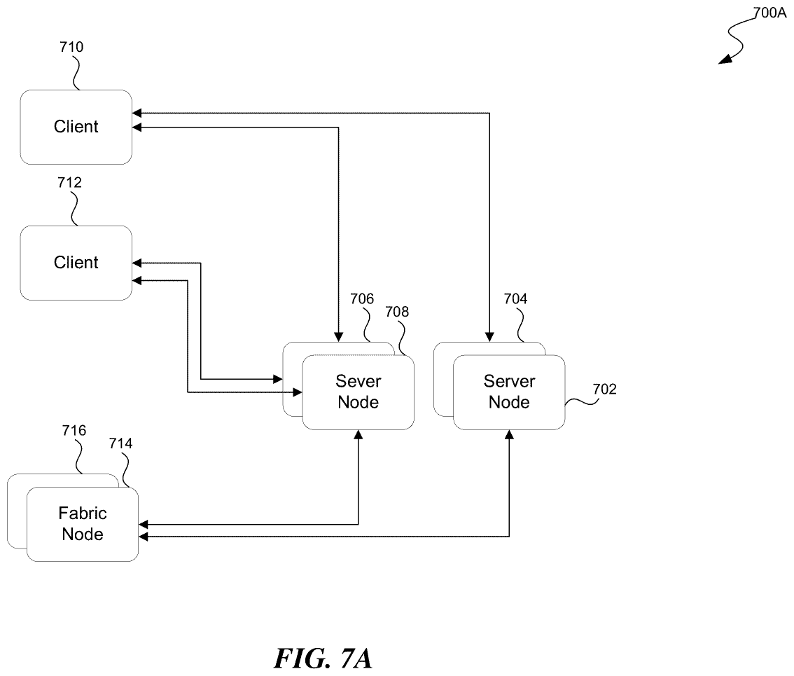

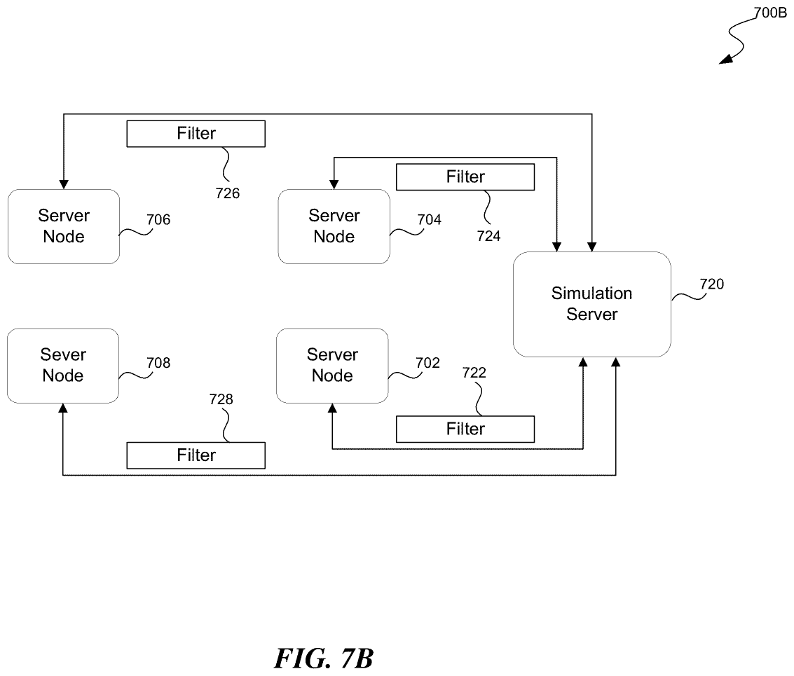

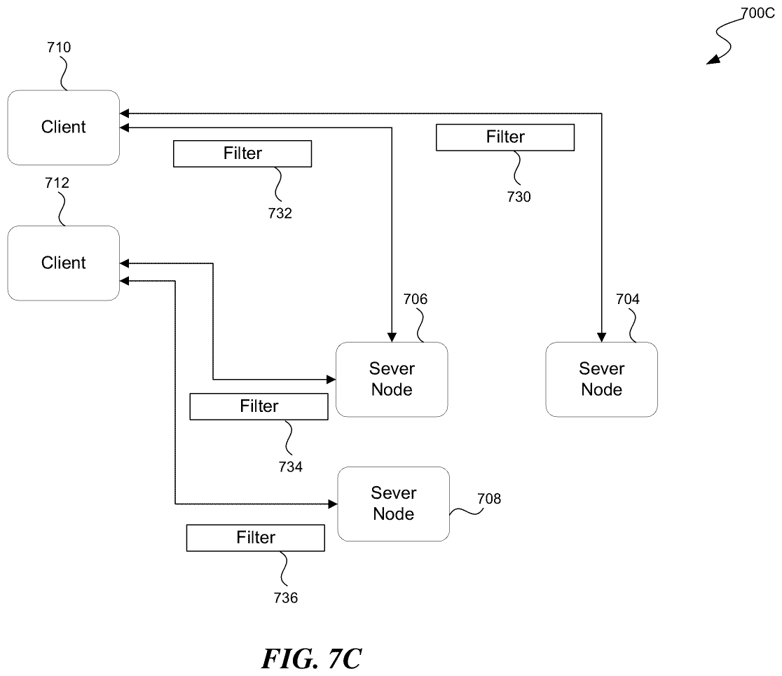

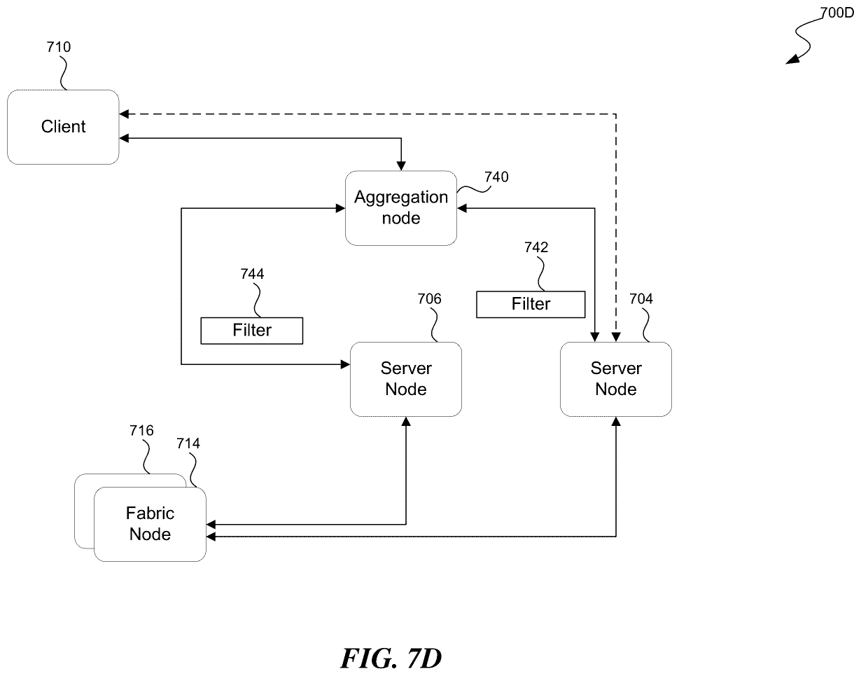

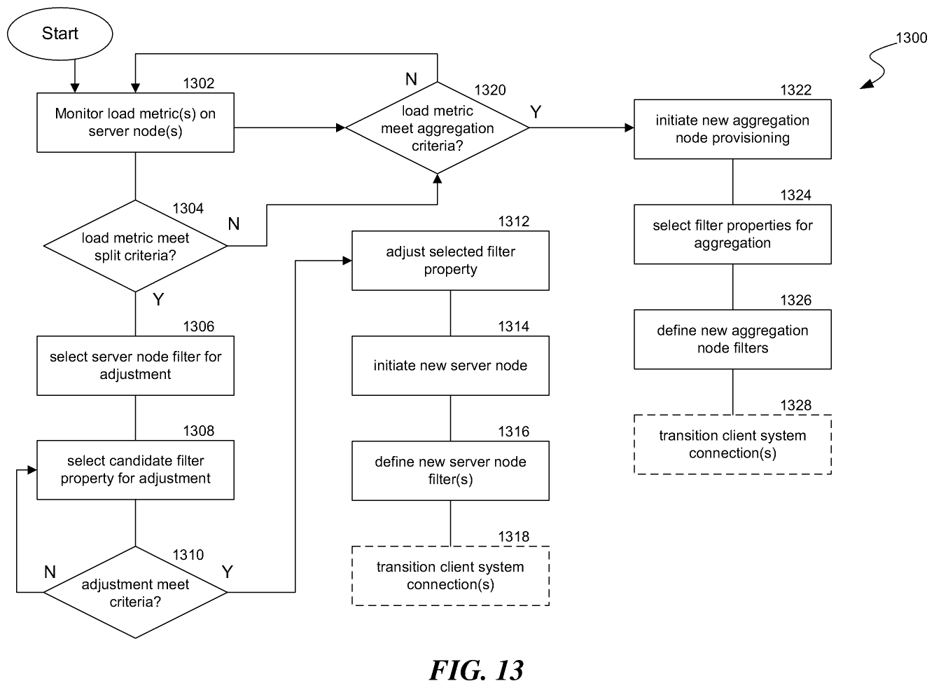

Node manager(s) 438 can manage server nodes and/or aggregation nodes of the mesh network. For example, node manager(s) 438 can monitor a load on server nodes of the mesh network, cause the initiation of a new server node (e.g., trigger the split of an existing server node), cause the initiation of an aggregation node, or perform other suitable node manager functionality. In some implementations, node manager(s) 438 can be implemented by one or more fabric nodes. Descriptions with references to FIGS. 7D and 13 further describe the functionality of node manager(s) 438.

Client controller(s) 440 can manage operation for one or more client systems in communication with the mesh network. For example, client controller(s) 440 can define client filters for the client system (e.g., based on the world state data requirements for an application running at the client system that implements a software application environment), submit requests for world state data to the mesh network, establish connections with one or more server nodes/aggregation nodes of the mesh network, transmit entity state update message to the mesh network, and perform other suitable operation functionality for client systems. Descriptions with references to FIGS. 5, 10, 14 and 15 further describe the functionality of client controller(s) 440.

Entity selector(s) 442 can select entities for display at a client system. For example, entities can be any suitable entity in a software application environment, such as a user presence (e.g., avatar), virtual object (e.g., non-player user entity), scene components, or any other suitable entity. In some implementations, the world state data propagated by implementations of the mesh network can be organized as state updates for one or more entities. Entity selector(s) 442 can select set(s) of entities (or select subset(s) from an initial set of entities) for display to a user via the user's client system. In some implementations, client controller(s) 440 can update local entity states stored at client system(s) using the world state data received from the mesh network, and entity selector(s) 442 can compare the local entity states to one or more display criteria to select entities for display to the user in the software application environment. Descriptions with references to FIGS. 5, 6, 7A, 7B, 7C, 7D, 10, and 11-15 further describe the functionality of entity selector(s) 442.

FIG. 5 is a block diagram illustrating system components to propagate multi-dimensional world state data from a mesh network to client systems by applying multiple levels of filters. System 500 includes server nodes 502, fabric nodes 504, simulation servers 506, and client systems 508. For example, implementations of the mesh network can include server nodes 502 and fabric nodes 504. The server nodes 502 can receive filtered world state data from simulation servers 506. For example, simulation servers 506 can perform software application environment processing (e.g., game server simulations) that generates world state data for the software application environment, such as updated entity locations, actions, poses, and the like. This world state data is considered transient because simulation servers 506 can, as time progresses, perform additional software application environment processing that generates new (e.g., updated) world state data. Implementations of fabric nodes 504 can manage the filters for server nodes 502. For example, the multi-dimensional world state data propagated through the mesh network can be portioned across server nodes 502 using the filters assigned by fabric nodes 504. Examples of a software application environment include a two-dimensional software environment, a three-dimensional software environment, a XR environment, an immersive environment, any other suitable software environment, or any combination thereof.

In some implementations, the world state data generated by simulation servers 506 and propagated through the mesh network can comprise multi-dimensional entity state data. An entity can be any suitable software application environment entity, such as a user presence (e.g., avatar), virtual object, scene elements, or any other suitable software application environment entity. In some implementations, data for an entity's state is defined by multiple property dimensions and property dimension values. Example property dimensions for entity state data include one or more of: software application environment instance identifier, software application environment location (e.g., three-dimensional vector that represents an entity's location in a XR environment instance), social graph metric, real-world connection location (e.g., real-world location from which the user's client system connects to the mesh network), any other suitable property dimensions, or any combination thereof. In some implementations, world state data also includes software application specific dimension properties. For example, a concert software application environment can generate different world state data relative to a user, such as data generated from performers on a stage and data generated from a crowd adjacent to the user. In this example, a data class (e.g., performer or audience) can be an application specific dimension property of the world state data.

In some implementations, fabric nodes 504 define filters for server nodes 502 that portion the world state data using data values of the world state data dimensions. In a simplified example, a first set of server nodes 502 can be portioned to a first three-dimensional volume of a XR environment (e.g., defined by data values of the XR environment location dimension) and a second set of server nodes 502 can be portioned to a second three-dimensional volume of the XR environment. In this example, fabric nodes 504 assign a first filter to the first server node with defined data values of the XR environment location dimension that correspond to the first three-dimensional volume and a second filter to the second server node with defined data values of the XR environment location dimension that correspond to the second three-dimensional volume. World state data from simulation servers 508 is then selectively filtered by the defined first and second filters to portion the world state data across the first and second server nodes. In other examples, the first and second filters can be defined by data values for a plurality of the world state data dimensions such that a topology of the multi-dimensional world state data is apportioned to each of the first and second server nodes.

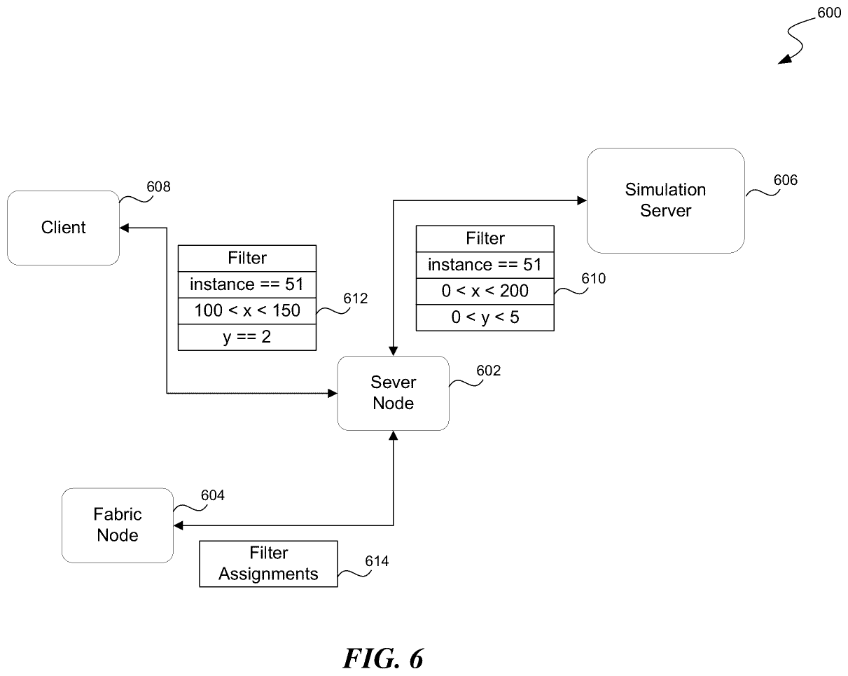

FIG. 6 is a diagram illustrating multiple levels of filters that are applied to world state data. Diagram 600 depicts server node 602, fabric node 604, client system 608, filters 610 and 612, and filter assignments 614. In some implementations, world state data received at server node 602 from simulation server 606 is filtered according to filter 610 (e.g., according to the defined data values for world state dimensions), and world state data from server node 602 received at client system 608 is filtered according to filter 612. In this example, the mesh network (e.g., server node 602 and fabric node 604) propagates world state data from simulation server 606 to client system 608 via multiple levels of filters, namely filters 610 and 612. Filter 610 can comprise a scope (e.g., topology of multi-dimensional world state data defined by data values for world state dimensions) that encompasses at least a portion of the scope of filter 612. Because of the scope overlap for these filters, server node 602 will receive world state data that is encompassed by filter 612 and can provide this data to client system 608. In some implementations, fabric node 604 instructs client system 608 to connect with server node 602 based on this scope overlap (e.g., so that client system 608 can receive the world state data encompassed by filter 612).

In some implementations, filters 610 and 612 include one or more expressions that define: a) one or more dimensions of world state date; b) one or more values (e.g., a range of values) for the dimensions; and c) one or more operators (e.g., mathematical operators). For example, filter 610 includes dimension properties ‘instance’, ‘x’, and ‘y’. The dimension ‘instance’ can represent a software application environment instance dimension, the dimension ‘x’ can represent a simplified software application environment location dimension, and the dimension ‘y’ can represent a simplified application class (e.g., membership in a group, where the numerals 1-5 represent different groups). Filter 610 can include other dimensions such as social graph metric (e.g., vector), user skill rating relative to the software application, or any other suitable dimension. Filter 610 also includes one or more values and operators for dimensions: ‘instance==51, 0<x<200, and 0<y<5’. In this example, world state data is encompassed by filter 610 when the data is: a) for software application environment instance 51; b) related to an entity (e.g., avatar, virtual object, etc.) at a software application environment location between 0 and 200, and c) related to an entity comprising an application class between 0 and 5.

The world state data generated by simulation server 606 encompassed by filter 610 can be received at server node 602. In some implementations, server node 602 can request world state data from simulation server 606 using filter 610. For example, server node 602 can issue a data request to simulation server 606 using the parameters defined in filter 610 to retrieve the relevant world state data. In another example, simulation server 606 can store filter 610, apply filter 610 to the world state data generated, and transmit the relevant data to server node 602.

The world state data held at server node 602 can be propagated to multiple client systems, for example when those client systems comprise filters that encompass this world state data. Client system 608 comprises filter 612 which includes the world state dimensions ‘instance’, ‘x’, and ‘y’, and the data values: instance==51, 100<x<150, and y==2. In this example, world state data is encompassed by filter 612 when the data is: a) for software application environment instance 51; b) related to an entity (e.g., avatar, virtual object, etc.) at a software application environment location between 100 and 150; and c) related to an entity comprising an application class 2. In this example, the scope of filter 612 is contained by the scope of filter 610, and thus the data encompassed by filter 612 is available at server node 602.

The world state data stored at server node 602 encompassed by filter 612 can be received at client system 608. In some implementations, client system 608 can request world state data from server node 602 using filter 612. For example, client system 608 can issue a data request to server node 602 using the parameters defined in filter 612 to retrieve the relevant world state data. In another example, server node 602 can store filter 612, apply filter 612 to the world state data stored at the server node, and transmit the relevant data to client system 608.

In some implementations, filters assigned (e.g., by fabric node(s)) to server nodes can include a software application environment location dimension parameter and data values that bound this dimension, such as a XR environment location and three-dimensional vector data value bounds. For example, the filter can define ‘Pos inside (750,250,0)-(1000,500,250)’ to apportion this volume of an XR environment to a server node. In some implementations, a client system can similarly define client filter(s) that comprises a XR environment location dimension parameter using three-dimensional vector boundaries. The following is an example client filter that includes the dimension parameters XR environment instance, XR environment location, social graph metric, and proximity to a user can: (Instance==53; Pos inside (750,250,0)-(1000,500,250); Social near vector [83, 23, 843], and Pos inside radius 50 of (750,250,0)).

In some implementations, a first filter parameter for a client filter can have a first refresh rate and a second filter parameter can have a second refresh rate. For example, a client filter can define a first refresh rate for the filter parameter ‘Pos inside radius 50 of (750,250,0)’ and a second refresh rate for the filter parameter ‘Pos inside radius 200 of (750,250,0)’, where the first refresh rate has a higher frequency than the second refresh rate. In this example, a server node/aggregation node that applies such a client filter to world state data can provide, to the client system, updated world state data filtered according to the first parameter at the first refresh rate and updated world state data filtered according to the second parameter at the second refresh rate.

In some implementations, a client filter can include a filter parameter defined by an expression with an exclusion indicator value (e.g., 0, false, etc.) that excludes the data defined in the expression. For example, the expression can exclude world state data within some distance (e.g., 1 unit, a threshold 3-dimensional distance, etc.) from anchor dimension data value(s). In this example, the client system can receive some world state data from multiple server nodes/aggregation nodes, and a filter parameter that excludes world state data can reduce redundant world state data transmissions from the mesh network to the client system.

In some implementations, fabric node 604 can assign filter 610 to server node 602. For example, fabric node 604 can apportion the world state data generated by simulation server 606 to multiple server nodes by assigning each a defined filter that covers a portion of the world state data. In some implementations, when client system 608 establishes a connection with the mesh network, alters one or more aspects related to the software application environment (e.g., teleports to a new location in a XR environment, joins a new group, etc.), or the like, client system 608 can transmit a request to fabric node 604 that identifies the world state data requested by the client system (e.g., provide fabric node 604 a filter that defines the world state data requested by client system 608).

Fabric node 604 can compare the world state data from client requests to the defined filters for the server nodes and identify one or more matching server nodes that can satisfy the requested data. Fabric node 604 can then instruct client system 608 to connect to the one or more matching server nodes such that the requested data can be propagated to client system 608. In the example illustrated in diagram 600, fabric node 604 can instruct client system 608 to connect to server node 602 based on filter 610 encompassing the scope of filter 612 (e.g., fabric node 604 can identify server node 602 as a match for client system 608, based on the scope of filter 610 encompassing the scope of filter 612).

FIG. 7A is a diagram illustrating server nodes, fabric nodes, and client systems that are used to propagate world state data. Diagram 700A depicts server nodes 702, 704, 706, and 708, client systems 710 and 712, and fabric nodes 714 and 716. Server nodes 702, 704, 706, and 708 can be similar to server node 502 of FIG. 5 and/or server node 602 of FIG. 6. Fabric nodes 714 and 716 can be similar to fabric node 504 of FIG. 5 and/or fabric node 604 of FIG. 6. Client systems 710 and 712 can be similar to client system 508 of FIG. 5 and/or client system 608 of FIG. 6. In some implementations, one or more of fabric nodes 714 and 716 can assign filters to server nodes 702, 704, 706, and 708 that each encompass varying scopes of multi-dimensional world state data (e.g., comprise different topographies of multi-dimensional world state data).

FIG. 7B is a diagram illustrating filters applied to world state data between server nodes and a simulation server. Diagram 700B depicts server nodes 702, 704, 706, and 708, simulation server 720, and filters 722, 724, 726, and 728. In an example, one or more of fabric nodes 714 and 716 can assign filter 722 to server node 702, filter 724 to server node 704, filter 726 to server node 706, and filter 728 to server node 708. In this example, the filters for these server nodes can define the topology of multi-dimensional world state data assigned to each server node. As described with reference to FIG. 6, server node filters can define a topology of multi-dimensional world state data, for example based on defined dimensions of the world state data and defined data values that bound these defined dimensions. Filters 722, 724, 727, and 728 can each correspond to a topology of the multi-dimensional world state data provided/generated by simulation server 720 such that the portions of multi-dimensional world data apportioned to server nodes 702, 704, 706, and 708 are defined by the topologies of filters 722, 724, 726, and 728.

In some implementations, simulation server 720 can simulate the dynamics of a shared software application environment. For example, in a shared software application environment that represents a sports game, a first user may perform an action within the context of the sports game (e.g., shoot a ball, pass a ball, make contact with a second user, etc.) and simulation server 720 can simulate the dynamics of this action to generate updates to the world state data for the software application environment. In this example, the updates may include changes to the location and/or movement metric of a virtual object (e.g., ball), changes to application specific environment data (e.g., a score for the sports game, a timer for the sports game, etc.), changes to the location, movement, and/or state of another user (e.g., whether the user is in possession of the ball, etc.), and other suitable world state data updates.

In another example, in a shared software application environment that represents an entertainment event and/or venue (e.g., a music concert, movie theater, sporting event, etc.), one or more entities within the software application environment may perform an action within the context of the entertainment event and/or venue and simulation server 720 can simulate the dynamics of this action to generate updates to the world state data for the software application environment. For example, one or more performers may move about a performance stage while one or more audience members proximate to a user make movements along with the performance. In this example, the updates may include changes to the location and/or movement metric of one or more entities of the software application environment (e.g., the performers, fellow audience members, etc.) and other suitable world state data updates.

In another example, in a shared software application environment that represents a world editing environment, one or more entities within the software application environment may perform an action to edit the shared world and simulation server 720 can simulate the dynamics of this action to generate updates to the world state data for the software application environment. For example, one or more users can edit virtual objects in the shared software application environment and/or move about the environment to interact with virtual objects. In this example, the updates may include changes to the location, movement metric, and/or structure of a virtual object, changes to the location, movement, and/or state of another user, and other suitable world state data updates.

In another example, in a shared software application environment that represents a massively multiple online game (MMOG), many users and/or virtual objects (e.g., non-player entities) can perform numerous actions in the context of the MMOG and simulation server 720 can simulate the dynamics of these actions to generate updates to the world state data for the software application environment. For example, the actions can include battle actions during a fight sequence (e.g., swinging a sword, casting a spell, etc.), movement actions (e.g., walking, running, teleporting, etc.), application specific actions (e.g., equipping a weapon or armor, using an item, etc.), and other suitable MMOG actions. In a shared virtual environment, several players can perform different actions in close proximity to one another and/or at different locations of the software application environment. In this example, the updates may include changes to the location and/or movement metric of a virtual object (e.g., non-player entity), changes to application specific environment data (e.g., the hit points/health of a user or non-player entity, a mana level for users, equipment, tools, and/or weapons equipped for users, etc.), changes to the location, movement, and/or state of another user, and other suitable world state data updates.

Any other suitable shared software application environment (e.g., XR environment) and simulated dynamics can be implemented by simulation server 720. While only a single simulation server 720 is depicted, the simulation dynamics for the shared software application environment can be assigned to several different simulation servers, and server nodes 402, 404, 406, and 408 can receive world state data (in accordance with their assigned filters) from these several simulation servers.

In some implementations, multi-dimensional world state data simulated by simulation server 720 can be filtered according to filters 722, 724, 726, and 728 and received at server nodes 702, 704, 706, and 708. For example, the filters 722, 724, 726, and 728 can split the multi-dimensional world state data into four different topologies, where each server node receives and manages the topology of data in accordance with its defined filter. In some implementations, the topology of data assigned to/managed by server nodes 702, 704, 706, and 708 can overlap with world state data requested by one or more client systems (e.g., overlap with the scope of client filters).

FIG. 7C is a diagram illustrating filters applied to world state data between server nodes and client systems. Diagram 7000 depicts server nodes 704, 706, and 708, client systems 710 and 712, and filters 732, 734, and 736. As illustrated in diagram 700B, server nodes 704, 706, and 708 can receive (e.g., from simulation server 720) topologies of multi-dimensional word state data (e.g., defined by the filter assigned to each server node). Multi-dimensional world state data from server nodes 704, 706, and 708 can be propagated to client systems 710 and 712 according to the filters defined by the client systems, such as filters 730 and 732 for client system 710 and filters 734 and 736 for client system 712.

In some implementations, client systems 710 and 712 can define their own filters, for example according to the requirements of one or more applications participating in the shared software application environment running at the client systems. Example applications running at client systems 710 and 712 that participate in the shared software application environment can include a sports game, entertainment event/venue application, MMOG, or any other suitable application. As described with reference to FIG. 6, client filters can define a topology of multi-dimensional world state data, for example based on defined dimensions of the world state data and defined data values that bound these defined dimensions.

Client system 710 can define filters 730 and 732. For example, the scope of filters 730 and 732, in combination, can meet the data requirements of the application(s) running at client system 710. In some implementations, filter 730 can comprise overlapping scope with the multi-dimensional world state data received at/managed by server node 704 (e.g., defined by filter 724 of FIG. 7B) and filter 732 can comprise overlapping scope with the multi-dimensional world state data received at/managed by server node 706 (e.g., defined by filter 726 of FIG. 7B). In this example, client system 710 can establish connections with both server node 704 and server node 706 to satisfy the scope of data requested by the application(s) running at client system 710.

For example, when client system 710 first connects to the mesh network, alters the multi-dimensional world state data requested by the client system, or otherwise adjusts its data requirements from the mesh network, client system 710 can transmit a request to fabric node(s) of the mesh network (e.g., fabric nodes 714 and 716 of FIG. 7A) that comprises an indication of the client's requested multi-dimensional world state data. For example, the indication can be in the form of a filter with defined dimensions and dimension data values that correspond to a topology of the multi-dimensional world state data. The fabric node(s) can match the client requested multi-dimensional world state data to one or more server nodes, for example by identifying assigned server node filters that overlap with the client's requested data.

In some implementations, indicator(s) for the matching server node(s) can be transmitted from the fabric node(s) to client system 710. Client system 710 can then connect to the matching server node(s) using the indicator(s), such as server nodes 704 and 706. In some implementations, client system 710 can split the data requested by the application(s) running at the client system based on the multi-dimensional world state data received at/managed by the matching server node(s) (e.g., each server node's assigned filter). For example, an overall filter that represents the global multi-dimensional world state data requirements by the application(s) running at client system 710 can be split into two different filters (e.g., filters 730 and 732), where each of the two filters is encompassed by the filter scope for one of the matching server node(s). In the example illustrated in diagram 7000, a global client filter for client system 710 is split into filters 730 and 732, where filter 730 is encompassed by the filter assigned to server node 704 (e.g., filter 724 of FIG. 7B) and filter 732 is encompassed by the filter assigned to server node 706 (e.g., filter 726 of FIG. 7B). In some implementations, the client filter split can be performed by the one or more fabric nodes. For example, matching the server nodes to the client-requested data can include splitting the client requested data into multiple filters that are encompassed by different ones of the matching server nodes. In this example, the fabric node(s) can transmit the split client filter to client system 710 and/or the matching server nodes such that the filters can be used to propagate world state data.

In some implementations, multi-dimensional world state data simulated by a simulation server (e.g., simulation server 720 of FIG. 7B) is propagated to client system 710 via server nodes 704 and 706. For example, server node 704 a) receives multi-dimensional world state data filtered in accordance with the server node's assigned filter, b) applies filter 730 to generate multi-dimensional world state data in accordance with client system 710's client filter, and c) propagates the client filtered data to client system 710. Similarly, server node 706 a) receives multi-dimensional world state data filtered in accordance with the server node's assigned filter, b) applies filter 732 to generate multi-dimensional world state data in accordance with client system 710's client filter, and c) propagates the client filtered data to client system 710. In this example, the global multi-dimensional data requirements of the application(s) running at client system 710 are satisfied by combining the data filtered according to filters 730 and 732 from server nodes 704 and 706. In some implementations, the application running at client system 710 can serialize the received multi-dimensional world state data, update state data for one or more entities, and execute the shared software application environment using the updated entity state data.

Similarly, multi-dimensional world state data simulated by a simulation server is propagated to client system 712 via server nodes 706 and 708. For example, server node 706 a) receives multi-dimensional world state data filtered in accordance with the server node's assigned filter, b) applies filter 734 to generate multi-dimensional world state data in accordance with client system 712's client filter, and c) propagates the client filtered data to client system 712. Similarly, server node 708 a) receives multi-dimensional world state data filtered in accordance with the server node's assigned filter, b) applies filter 736 to generate multi-dimensional world state data in accordance with client system 712's client filter, and c) propagates the client filtered data to client system 712. In this example, the global multi-dimensional data requirements of the application(s) running at client system 712 are satisfied by combining the data filtered according to filters 734 and 736 from server nodes 706 and 708. In some implementations, the application running at client system 712 can serialize the received multi-dimensional world state data, update state data for one or more entities, and execute the shared software application environment using the updated entity state data.

The example implementation illustrated in diagram 7000 comprises two client connections for server node 706 (e.g., to both client systems 710 and 712). At times server nodes can have a large number of connections with client systems and/or can manage/receive large volumes of multi-dimensional world state data, for example based on the scope of the filter assigned to the server node and/or how often the server node's data is requested by client systems (e.g., covered by client filters). In some implementations, aggregation nodes can aggregate multi-dimensional world state data from one or more server nodes to mitigate the workload on a given server node, improve latency with client systems, among other benefits.

FIG. 7D is a diagram illustrating server nodes, aggregation nodes, fabric nodes, and client systems that are used to propagate world state data. Diagram 700D depicts server nodes 704 and 706, client system 710, fabric nodes 714 and 716, aggregation node 740, and filters 742 and 744. In some implementations, one or more of fabric nodes 714 and 716 assign one or more filters (e.g., filters 742 and 744) to aggregation node 740 such that multi-dimensional world state data from one or more server nodes (e.g., server nodes 704 and 706) is filtered and received at aggregation node 740. In some implementations, the one or more filters assigned to aggregation node 740 can define a topology of multi-dimensional world state data, for example based on defined dimensions of the world state data and defined data values that bound these defined dimensions. In the example illustrated in diagram 700D, aggregation node receives multi-dimensional world state data from both server node 704 and server node 706, and thus a filter can be defined for each of the aggregation node's connections to a server node.

For example, one or more of fabric nodes 714 and 716 can assign aggregation node 740 a global filter that defines a global scope for the multi-dimensional world state data stored by aggregation node 740, as well as filters 742 and 744, or source specific filters that breakdown the global filter into two components that correspond to the scope of server filters assigned to server nodes 704 and 706 (e.g., the server nodes that source aggregation node 740 with multi-dimensional world state data). For example, filter 742 can be encompassed by the scope of the server filter assigned to server node 704 and filter 742 can be encompassed by the scope of the server filter assigned to server node 706. In this example, the global filter can be used to match client requested multi-dimensional world state data to the aggregation node, while filters 742 and 744 can be used to filter multi-dimensional world state data received by aggregation node 740.

In another example, one or more of fabric nodes 714 and 716 can assign aggregation node 740 filters 742 and 744 (e.g., the source specific filters). In this example, a separate global filter is not assigned, but rather the global filter (e.g., used to match client requested multi-dimensional world state date with aggregation node 740) is accomplished by combining filters 742 and 744. For example, when one or more of fabric nodes 714 and 716 match a client request to the mesh network, the fabric nodes can compare the combined filters 742 and 744 to the client request to determine whether aggregation node 740 is a match for the client requested data.

In some implementations, a node controller (e.g., resident at one of fabric nodes 714 and 716, or at any other suitable computing device), monitors a load on server nodes 704 and 706 and causes the initiation of aggregation node 740 based on the monitored load. For example, the load on the server nodes can be one or more client system connections for the server node, a volume of data received by/managed at the server node, a computing resource utilization metric (e.g., processors utilization, memory utilization, etc.), or any other suitable load metric. When the load on one or more of server nodes 704 and 706 meets a criteria (e.g., number client connections threshold, volume of data threshold, computing resource utilization threshold, etc.), the node controller can initiate aggregation node 740. In some implementations, aggregation node 740 can be initiated based on any other suitable conditions.

In response to the initiation, one or more fabric nodes 714 and 716 can assign filter(s) to aggregation node 740, for example filter(s) that selectively offload server node 704 and/or server node 706. In some implementations, client connections to server nodes are based on an overlap between client filters and server filters. Aggregation node 740 can be assigned filter(s) that encompass one or more client filters so that client connections can be migrated from server node 704 and/or server node 706 to aggregation node 740. In some implementations, client system 710 is connected to aggregation node 740 (e.g., the client connection is migrated from one or both of server nodes 704 and 706) and multi-dimensional world state data can be propagated to client system 710 via server nodes 704 and 706, and aggregation node 740. For example, aggregation node 740 can receive multi-dimensional world state data from server node 704 filtered according to filter 742 and multi-dimensional world state data from server node 706 filtered according to filter 744. Aggregation node 740 can then filter the received multi-dimensional world state data according to a client filter for client system 710 such that the client filtered multi-dimensional world state data can be propagated to client system 710.

In some implementations, client system 710 can comprise a connection to aggregation node 740 and server node 704. For example, client system 710 can comprise two client filters (e.g., similar to filters 730 and 732 of FIG. 7C) where a first client filter overlaps with the multi-dimensional world state data received at/managed by aggregation node 740 and a second client filter overlaps with the multi-dimensional world state data received at/managed by server node 704. In this example, although server node 704 sources aggregation node 740 with world state data, the scope of world state data received at/managed by these nodes may be different. Due to these scope differences, client system 710 may require a connection with both server node 704 and aggregation node 710 to secure the totality of world state data requested by the software application running at the client system.

In some implementations, one or more of fabric nodes 714 and 716 can select the filter dimensions and filter dimension values for aggregation node 740 based on: a number of client systems impacted; b) an amount of data offloaded from one or more of server nodes 704 and 706; c) a predetermined selection policy; d) any other suitable metric; e) or any combination thereof. For example, fabric nodes 714 and 716 can simulate one or more aggregation node filters (e.g., defined world state data dimensions and dimension value(s)) and determine an amount of world state data that the simulated aggregation node filter(s) would cover and/or a number of client systems that the simulated aggregation node filter(s) would cover. When the amount of world state data and/or number of client systems meets a criteria, the simulated aggregation node filter(s) can be selected for aggregation node 740.

In some implementations, a predetermined selection policy can be defined for a shared software application environment, such as one or more predefined world state data dimensions for use to define filter(s) for aggregation nodes. In an example, XR environment location can be a default world state data dimension on which to aggregate world state data using an aggregation node for an XR environment software application. In this example, subsets of the coverage of server filters for server nodes 704 and 706 relative to the XR environment location dimension can be selected for the filter(s) defined for aggregation node 740.

In some implementations, the multi-dimensional world state data propagated through the mesh network is subdivided among server nodes and/or aggregation nodes using the filters assigned by fabric nodes. For example, each server node and/or aggregation node can correspond to a topology of the multi-dimensional world state data (e.g., scope) that is defined by the node's assigned filter(s). In some implementations, the scope of a first server node can be adjacent to the scope of a second server node, for example so that gaps in the overall topology of multi-dimensional world state data are avoided.

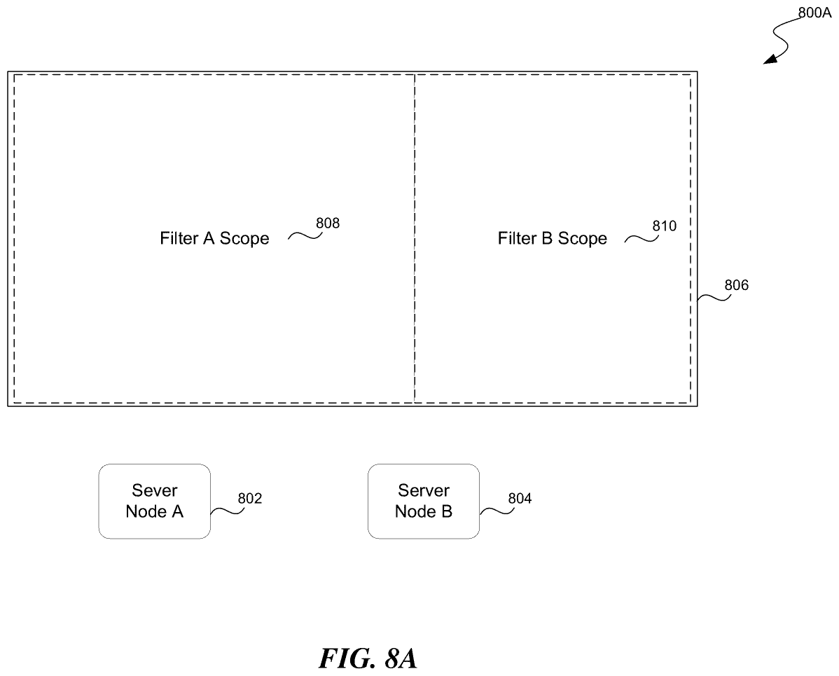

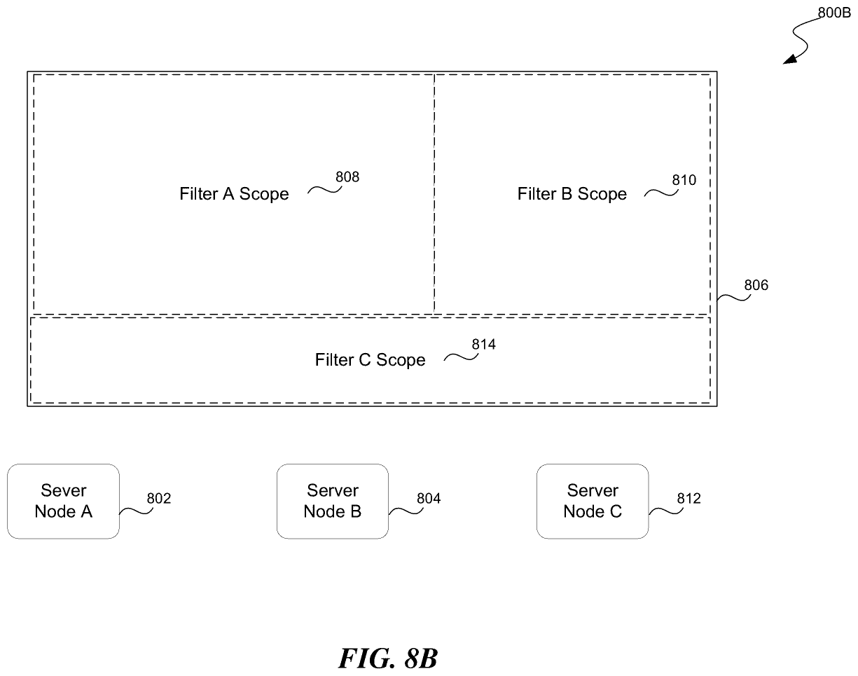

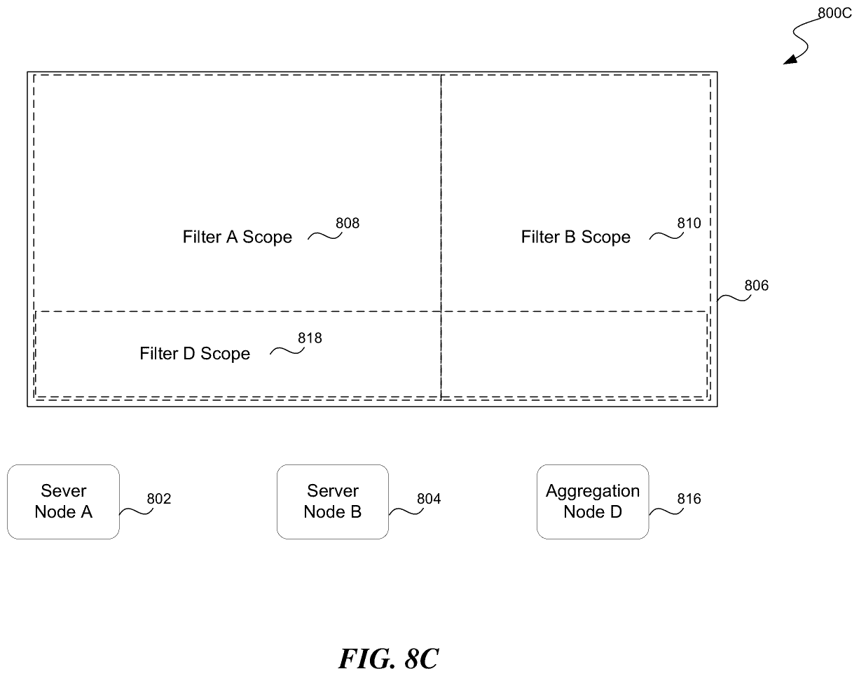

FIG. 8A is a diagram illustrating defined filters for two server nodes and their corresponding scopes. Diagram 800A depicts server node A 802, server node B 804, combined filter scope 806, filter A scope 808, and filter B scope 810. In some implementations, filter A scope 808 represents the topology of multi-dimensional world state data that corresponds to the filter(s) assigned to server node A 802, filter B scope 810 represents the topology of multi-dimensional world state data that corresponds to the filter(s) assigned to server node B 804, and combined filter scope 806 represents the topologies of both combined. In the illustrated example, filter A scope 808 and filter B scope 810 are adjacent to one another such that their combination generates combined filter 806. In a simplified example, given the world state data dimension software application environment location ‘X’, the filter definition for server node A may cover dimension data values ‘A<X<B’ while the filter definition for server node B may cover dimension data values ‘B<X<C’. In this simplified example, combined filter scope 806 covers ‘A<X<C’. This is a simplified example, and in some implementations the actual coverage of filter A scope 808, filter B scope 810, and combined filter scope 806 are multi-dimensional topographies. Further, in some implementations, the filter A scope 808 and the filter B scope 810 have overlapping areas.

A node manager can cause the initiation (e.g., provisioning) of additional server nodes and/or aggregation nodes. In some implementations, the scope of filters assigned to new server nodes can be adjacent to existing server node coverage while the scope of a new aggregation node can overlap with existing server node coverage. FIG. 8B is a diagram illustrating defined filters for three server nodes and their corresponding scopes. Diagram 800B depicts server node A 802, server node B 804, server node C 812, combined filter scope 806, filter A scope 808, filter B scope 810, and filter C scope 814.

In the illustrated example, server node C 812 and filter C scope 814 are added to the mesh network to support the combined filter scope 806. For example, the topologies of filter A scope 808 and filter B scope 810 are reduced (e.g., by one or more fabric nodes that manage the filters for server nodes) and filter C scope 814 is defined (e.g., by the fabric nodes) to cover the reduction in filter A scope 808 and filter B scope 810. In other words, in some implementations when a new server node is added to the mesh network, the one or more fabric nodes reduce the scopes of filter A scope 808 and filter B scope 810 and define the scope of filter C scope 814 such that the entirety of combined filter scope 806 is covered. The continuous coverage ensures that a client request for multi-dimensional world state data (e.g., within the topology of combined filters scope 806) can be satisfied by at least one of server node A 802, server node B 804, or server node C 812.

FIG. 8C is a diagram illustrating defined filters for two server nodes an aggregation node and their corresponding scopes. Diagram 8000 depicts server node A 802, server node B 804, aggregation node D 816, combined filter scope 806, filter A scope 808, filter B scope 810, and filter scope D scope 818. In the illustrated example, aggregation node D 816 and filter D scope 820 are added to the mesh network to support the combined filter scope 806. For example, the topologies of filter A scope 808 and filter B scope 810 remain unchanged while filter C scope 814 is defined (e.g., by one or more fabric nodes that manage the filters for server nodes/aggregation nodes) to overlap with filter A scope 808 and filter B scope 810. In other words, in some implementations when an aggregation node is added to the mesh network, the one or more fabric nodes define filter C scope 814 to overlap with filter A scope 808 and filter B scope 810. The overlapping scope provides redundancy so that aggregation node D 816 can serve at least a portion of the client systems previously served by server node A 802 and/or server node B 804.

In some implementations, the scopes for filters assigned to server nodes can also be overlapping. For example, one or more server nodes can be replicated to generate multiple copies (e.g., copies that each comprise the same filter coverage), the scopes for filters assigned to server nodes that are adjacent to one another (e.g., filter A scope 808 and filter B scope 810) can comprise some overlapping portions, and/or any other suitable scope overlap can exist among the filters assigned to server nodes. In these examples, the redundancy provided by overlapping filters assigned to server nodes can support higher service level metrics for client systems of the mesh network. Further, the overlap allows users to seamlessly move between areas with server handoff without interruption to service.

In some implementations, replicas of server node(s) can be maintained as part of the mesh network. For example, a given server node with a given assigned filter can have several replicas (with the same given assigned filter) that are part of the mesh network. In some implementations, the replicas can be connected to (and propagate world state data to) different client systems. In other examples, one or more replicas can be on stand-by. Server nodes may experience faults or failure from time to time, and the mesh network can implement recovery protocols in these scenarios. For example, when a failed server node is detected, the fabric node(s) can reassign client systems connected to the failed server node to one or more of the replica nodes. In addition, the fabric node(s) can adjust filter assignments for the active server node(s)/replica node(s) to load balance given the new load conditions caused by the server node failure.

In some implementations, the multi-dimensional world state data propagated through the mesh network is generated by multiple simulation servers. For example, each simulation server can simulate shared software application environment dynamics (e.g., two-dimensional software environment dynamics, three-dimensional software environment dynamics, XR environment dynamics, immersive environment dynamics, etc.) to generate world state data for a portion of the shared software application environment that the simulation server implements. This portion can be defined by a simulation server filter, such as a set of dimensions and dimension values that bound the dimensions which represent a topology of the multi-dimensional world state data.

In some implementations, the mesh network can propagate multi-dimensional world state data from a simulation server to a plurality of client systems and to the other simulation servers that implement the shared software application environment. Accordingly, a simulation server that generates portions of world state data can also receive portions of world state data from other simulation servers. For example, one or more first simulation server filters can define the portion of multi-dimensional world state data generated by a given simulation server (e.g., via simulated shared software application environment dynamics) and one or more second simulation server filters can define the portion of multi-dimensional world state data requested by the given simulation server (e.g., from the other simulation servers that implement the shared software application environment). In some implementations, the data propagated from one simulation server to another is used to perform simulated shared software application environment dynamics. For example, in order to simulate the software application environment dynamics to generate the world state data a given simulation server is responsible for (e.g., covered by the first simulation server filter(s)), additional world state data from the other simulation servers may be required.

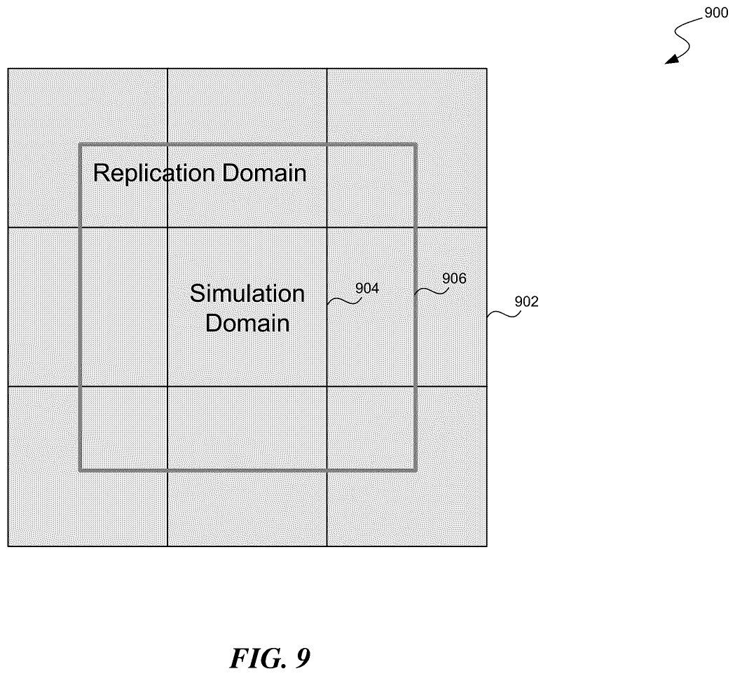

FIG. 9 is a diagram illustrating a simulation domain and a replication domain for a simulation server. Diagram 900 depicts world state domain 902, simulation domain 904, and replication domain 906. For example, world state domain 902 can represent the full scope of multi-dimensional world state data for a shared software application environment implemented by multiple simulation servers. For a given one of the multiple simulation servers, simulation domain 904 can represent the scope of multi-dimensional world state data that the given simulation server is responsible for generating and replication domain 906 can represent the scope of multi-dimensional world state data that the given simulation server requires in order to perform its responsible simulations (e.g., to simulate the set of dynamics of the shared software application environment required to generate the world state data the given simulation server is responsible for).

In illustrated example, replication domain 906 is larger than simulation domain 904. The mesh network can propagate multi-dimensional world state data from the other simulation servers that implement the shared software application environment to the given simulation server to provide the given simulation server the world state data required for its simulations. For example, one or more simulation server filters can be defined that receive/retrieve (e.g., from one or more server nodes and/or aggregation nodes) topographies of world state data based on defined dimensions and dimension values that bound the dimensions. In some implementations, the simulation server filters can be defined and managed by fabric nodes of the mesh network. The simulation servers can connect to one or more server nodes/aggregation nodes that receive/manage the world state data covered by the simulation server filters such that the requested world state data can be propagated from: a) source simulation server(s) to server node(s)/aggregation node(s); and b) from the server node(s)/aggregation node(s) to target simulation server(s). By receiving world state data that covers its replication domain 906, a simulation server can perform the relevant simulations to generate world state data that covers its simulation domain 904.

In some embodiments, as a user within the shared software application environment (e.g., user presence entity) interacts and moves, the entity that represents the user changes, the user entity can be owned/managed by different mesh network components, and the client filters for the client system operated by the user can update. For example, user interactions and movements can update client filters (e.g., the user entity's location in the software application environment, etc.) so that the client system associated with the user receives world state data relative to the user entity's current state.

In some implementations, user movement (or movement of any other suitable entity) in the software application environment can cross a boundary that divides the world state data apportioned to two different server nodes. In this example, both server nodes can receive and propagate the user entity's world state data for a period of time to ensure the handoff does not cause any world state data gaps. In some implementations, the simulation server responsible for simulating software application environment dynamics for an entity can change based on interactions and/or movements of the entity. In this example, a first simulation server can handoff the simulation responsibilities for the entity to a second simulation server. In some implementations, the replication domain (e.g., replication domain 906) maintained by simulation servers mitigates against data gaps so that the simulation server can seamlessly transition entity responsibilities.

In some implementations, the multi-dimensional world state data generated by the simulation servers and propagated by the mesh network is defined relative to one or more shared software application environment entities, such as a user representation (e.g., avatar), virtual object (e.g., non-player entity), or other suitable entities of a shared software application environment. In some implementations, the entities may comprise a definition organized as an entity schema, such as a data structure that stores world state data about the entities such that the entities can be displayed, presented, and/or interacted with in the shared software application environment.

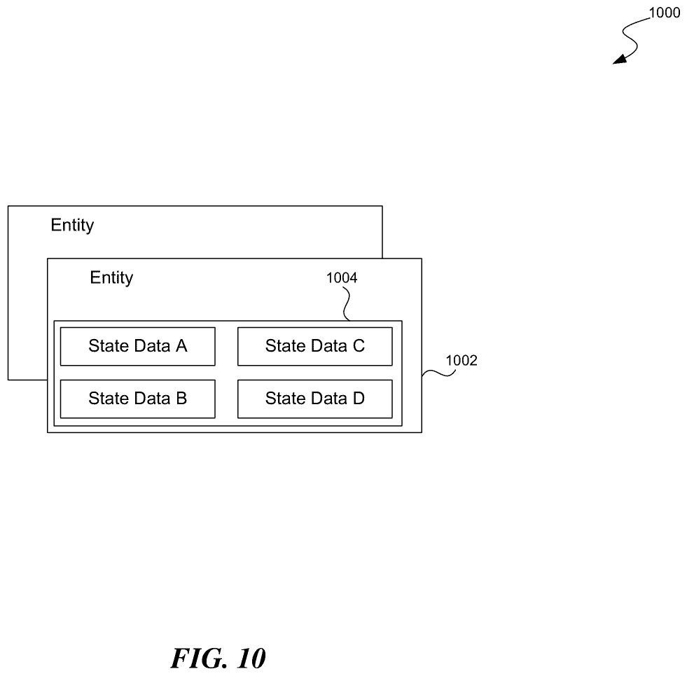

FIG. 10 a diagram illustrating an entity schema. Diagram 1000 depicts entity schemas 1002 and schema properties 1004. In some implementations, a shared software application environment can support one or more predefined types of entity schemas 1002. The supported entity schemas 1002 can comprise schema properties 1004 that store data values for an entity, such as a current location relative to the shared software application environment for the entity, movement data for the entity, information about the entity's display (e.g., avatar information, other suitable representation information), items (e.g., pointers to/identifiers for one or more item data structures) stored by/carried by the entity, and other suitable schema properties.

In some implementations, while implementing a shared software application environment, client systems can store entity states within data structures shaped in accordance with these one or more entity schemas 1002. When client systems receive world state data from the mesh network, the client systems can update the entity state stored in the entity data structures to reflect the world state data received (e.g., serialize the received world state data to update local entity states). These updates support a coordinated display of the shared software application environment across several client systems. For example, the mesh network propagates world state data to the client systems so that the displays of the entities at the client systems (e.g., within the shared software application environment) reflect the changes in the world state propagated through the mesh network (e.g., propagated from one or more simulation servers to the client systems).

In some implementations, simulation server(s) can also store entity states within data structures shaped in accordance with these one or more entity schemas 1002. For example, the stored entity states can be used by the simulation server(s) to simulate dynamics for the shared software application environment. In some implementations, the entity state stored by client systems and/or simulation servers can include entity metadata, such as entity identifier, creation time, modification time, responsible simulation server identifier, modified node identifier, parent entity identifier, and other suitable metadata. When a given entity moves in the software application environment to cause different client system(s) to store the given entity's state and/or different simulation server(s) to store the given entity's state (e.g., responsible simulation server and/or simulation server(s) that include the given entity in a replication domain), the different client system(s)/simulation server(s) can store the given entity's schema data structure and the given entity's metadata.

In some implementations, the server nodes and/or aggregation nodes of the mesh network propagate data structures similar to entity schemas 1002, however do not store persistent entity data structures. For example, while a client system can serialize received world state data to update a local version of a data structure that stores entity state(s), server nodes and/or aggregation nodes can propagate data structures without serializing the world state data to update local entity storage. In these examples, the world state data/entity states can be propagated through the mesh network as blobs of data. In some implementations, in order to perform filtering on the world state data, the server nodes/aggregation nodes can selectively access predefined portions of the blobs of data (e.g., data at an offset/offset range of bytes or bits) to extract relevant dimension data values, such as the software application environment location of a given environment entity defined by a given blob of data. In some implementations, the selectively accessing is achieved based a known structure for the blobs of data so that an offset/offset range corresponds to the world state data the server node/aggregation node requires to perform filtering. Using the accessed world state data, the server nodes/aggregation nodes can then propagate the blobs of data by applying the relevant filter definitions of the mesh network (e.g., client filters, server node filters, aggregation node filters, and/or simulation node filters).

Those skilled in the art will appreciate that the components illustrated in FIGS. 1-10 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

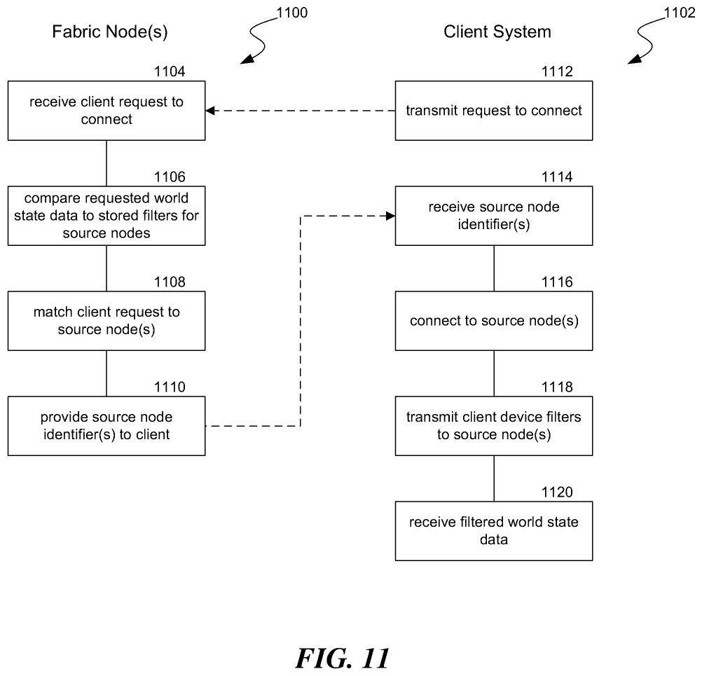

FIG. 11 is a flow diagram illustrating a process used in some implementations of the present technology for establishing a connection between a client system and a mesh network using one or more fabric nodes. In some implementations, processes 1100 and 1102 can be performed in response to initiation of a shared software application environment or during an ongoing shared software application environment. In some implementations, processes 1100 and 1102 can be performed ahead of time e.g., in advance of the initiation of the shared software application environment. In some implementations, process 1100 can be performed by fabric nodes of a mesh network and process 1102 can be performed by a client system that connects to a mesh network. Examples of a shared software application environment include a two-dimensional software environment, a three-dimensional software environment, a XR environment, an immersive environment, any other suitable software environment, or any combination thereof.

At block 1104, process 1100 can receive a client request to connect to the mesh network. The mesh network can comprise one or more fabric nodes and multiple server nodes. The client request can be received and processed by the one or more fabric nodes. For example, the fabric nodes can coordinate connections between client systems and the server nodes of the mesh network. In some implementations, the mesh network propagates multi-dimensional world state data from one or more simulation servers to client systems via the server nodes. In some implementations, the mesh network can also include aggregation nodes that aggregate multi-dimensional world state data from one or more server nodes. The fabric nodes can also coordinate connections between client systems and the aggregation nodes of the mesh network.

In some implementations, the client request includes a representation of the client requested world state data. For example, the representation can be a client filter that defines dimensions of the world state data and data values that bound the dimensions. The client filter can correspond to a topology of the multi-dimensional world state data requested by the client system.

At block 1106, process 1100 can compare the requested world state data to stored filters for source nodes. Example sources nodes include server nodes and/or aggregation nodes of the mesh network. In some implementations, the fabric nodes assign aggregation node filters and server node filters to each aggregation node and server node of the mesh network. These source node filters can define dimensions of the world state data and data values that bound these dimensions, the defined source node filters corresponding to topologies of the multi-dimensional world state data assigned to each source node.

In some implementations, the fabric node(s) can compare a scope for the client requested data (e.g., represented as a client filter) to the assigned filters of the source nodes. For example, the fabric nodes can compare a scope cover (e.g., assigned filter topology) of the source nodes to a requested scope coverage for the client requested world state data.

At block 1108, process 1100 can match the client request to one or more source nodes. For example, the fabric node(s) can identify one or more source nodes (e.g., server nodes and/or aggregation nodes) with assigned filters that satisfy the client requested world state data. In some implementations, source nodes that satisfy the client requested world state data (e.g., match the client request) comprise assigned filters that encompass the scope of the client filter. In some implementations, the fabric nodes can identify multiple source nodes that match the client requested data, where the combined scope of the filters assigned to the multiple matching source nodes encompasses a scope of the client filter (e.g., client requested data).

At block 1110, process 1100 can provide the matching source node identifier(s) to the client system. For example, fabric nodes can transmit identifiers for the matching source nodes (e.g., connection information that supports a client connection with the matching source nodes) to the client system.

At block 1112, process 1102 can transmit a request to connect to the mesh network. For example, a client system can transmit the request to one or more fabric nodes. The client request can include a representation of multi-dimensional world state data (e.g., a client filter) requested by the client system. Blocks 1104-1110 of process 1100 describes the fabric node(s) receiving the client request and subsequent processing at the fabric node(s).

In some implementations, the client system can be an XR system that implements a shared XR environment, for example displays the shared XR environment to a user. For example, the shared XR environment can be implemented across several client systems (e.g., displayed to several users via the several client systems), and the mesh network can propagate world state data of the shared XR environment to the client systems that supports a coordinated display of the XR environment at the client systems.

At block 1114, process 1102 can receive source node identifier(s) that match the request world state data. For example, the fabric node(s) can match source nodes (e.g., server nodes and/or aggregation nodes) to the client request and the client system can receive, from the fabric node(s), connection information for the matching source node(s). In some implementations, the matching sources nodes can provide the client system world state data requested by the client system at least based on a scope overlap between the matching source node assigned filter(s) and the client requested data (e.g., client filter).

At block 1116, process 1102 can connect to the identified source node(s). For example, the client system can use the connection information provided by the fabric node(s) to establish one or more connections with the source node(s). In some implementations, multiple source nodes are matched to the client request, and the client system establishes multiple connections to the source nodes, such as multiple connections with multiple server nodes.

At block 1118, process 1102 can transmit client filter(s) to the source node(s). For example, the client system can transmit at least one client filter to at least one matching source node over the established connection. The client filter can represent the multi-dimensional world state data (e.g., dimensions and dimension values that bound the dimensions, such as a defined topology) requested by the client system (e.g., requested by an application running at the client system that implements the shared XR environment).

In some implementations, multiple source node(s) are matched to the client requested data, and the client system transmits a client filter to each source node that corresponds with a scope of the source nodes' assigned filter. For example, not all the client requested data may be managed by a single source node of the mesh network. As a result, an overall client filter that represents the overall client requested data can be split into two filters. For example, a first client filter can be defined such that the assigned filter(s) for a first of the source nodes encompasses the first client filter and the second client filter can be defined such that the assigned filter(s) for a second of the source nodes encompasses the second client filter. The first and second client filters can be transmitted by the source system to the first and second source nodes, respectively.

At block 1120, process 1102 can received filtered world state data. For example, the client system can receive multi-dimensional world state data from the matching source node(s) filtered according to the transmitted client filter(s). The multi-dimensional world state data can be generated by one or more simulation servers that simulate dynamics for the shared XR environment, propagated through the mesh network, and received at the client system via the matching source node(s).

In some implementations, the world state data received at the client system can undergo multiple stages of filtering while being propagated through the mesh network. For example, the multi-dimensional world state data received from the simulation server(s) at the matching source node(s) can be filtered according to assigned source node filter(s), and the multi-dimensional world state data received from the matching source node(s) at the client system can be filtered according to assigned client filter(s).

In some implementations, at least two source nodes are matched to the client request, and the client system can receive world state data from both matching source nodes. For example, the multi-dimensional world state data received from the first matching source node can be filtered according to a first client filter (e.g., that corresponds to the first matching source node's assigned filter) and the multi-dimensional world state data received from the second matching source node can be filtered according to a second client filter (e.g., that corresponds to the second matching source node's assigned filter).

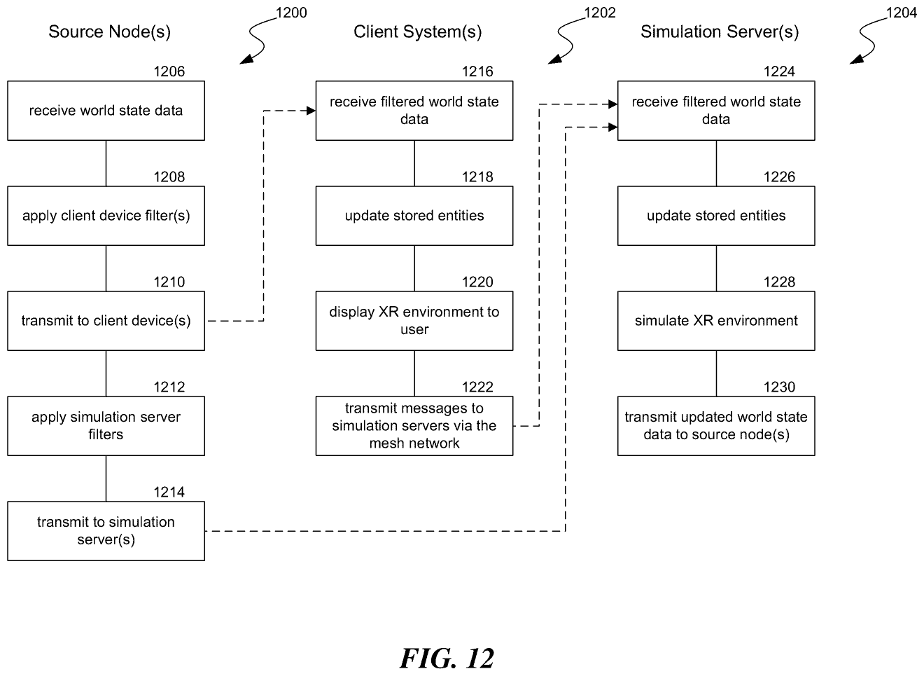

FIG. 12 is a flow diagram illustrating a process used in some implementations of the present technology for propagating multi-dimensional world state data from a mesh network to client systems by applying multiple levels of filters. In some implementations, processes 1200, 1202, and 1204 can be performed in response to initiation of a shared XR environment or during an ongoing shared XR environment. In some implementations, process 1200 can be performed by source nodes of a mesh network (e.g., server nodes and/or aggregation nodes), process 1202 can be performed by client systems, and process 1204 can be performed by simulation servers. Examples of a shared software application environment include a two-dimensional software environment, a three-dimensional software environment, a XR environment, an immersive environment, any other suitable software environment, or any combination thereof.

At block 1206, process 1200 can receive filtered world state data. For example, multiple source nodes of the mesh network (e.g., server nodes and/or aggregation nodes) can receive multi-dimensional world state data from one or more simulation servers that is filtered according to defined filters for the multiple source nodes. For example, one or more fabric nodes of the mesh network can assign aggregation node filters and server node filters to each aggregation node and server node of the mesh network. These source node filters can define dimensions of the world state data and data values that bound these dimensions, the defined source node filters corresponding to topologies of the multi-dimensional world state data assigned to each source node. In some implementations, the filtered world state data received at each server node and/or aggregation node comprises a topology that corresponds to the filter assigned to the node.

At block 1208, process 1200 can apply a plurality of client filters to the filtered world state data. For example, client systems can comprise connections with the source nodes of the mesh network. In some implementations, the fabric node(s) of the mesh network can match source nodes with client requested data to support establishment of connections between the client systems and source nodes. Implementations can match source nodes to client requested data as described with reference to FIG. 11 and processes 1100 and 1102.

In some implementations, the source node(s) connected to a given client system can store client filters that are specific to the given client system. For example, the client filter can define dimensions of the world state data and data values that bound the dimensions. The client filter can correspond to a topology of the multi-dimensional world state data requested by the client system. The client filter specific to the given client can be applied to the multi-dimensional world state data received at the source node to generate client filtered world state data.

In some implementations, a given source node is connected to several client systems, and a client specific filter is stored for each connected client system at the given source node. The client specific filters for each client system are applied to the world state data received at the given source node to generate client filtered world state data for each client system.

At block 1210, process 1200 can transmit the client filtered world state data to client systems. For example, for a given source node, the client filtered world state data generated for each client system (e.g., filtered according to the stored client filter specific to the client system) can be transmitted to the client system. In some implementations, the multiple source nodes of the mesh network can transmit specific client filtered data to each connected client system.

At block 1212, process 1200 can apply a plurality of simulation server filters to the filtered world state data. For example, the multi-dimensional world state data propagated through the mesh network can be generated by multiple simulation servers. In some implementations, each simulation server can simulate shared software application environment dynamics to generate world state data for a portion of the shared software application environment that the simulation server implements. This portion can be defined by a simulation server filter, such as a set of dimensions and dimension values that bound the dimensions which represent a topology of the multi-dimensional world state data. Similar to the propagation of world state data filtered according to specific client filters, source nodes can apply specific simulation server filters to the world state data received at the source nodes to generate simulation server filtered world state data.

At block 1214, process 1200 can transmit the simulation server filtered world state data to the simulation servers. For example, for a given source node, the simulation server filtered world state data generated for each simulation server can be transmitted to the simulation servers. In some implementations, the multiple source nodes of the mesh network can transmit specific simulation server filtered data to each connected simulation server.

At block 1216, process 1202 can receive client filtered world state data. For example, a client system can receive client filtered world state data from one or more source nodes of the mesh network. The source node(s) can store and apply, to the multi-dimensional data received at the source node(s), a client filter specific to the client system. In some implementations, the client filtered world state data meets the world state data requests of an application running at the client system that implements the shared software application environment.

In some implementations, the client system is connected to multiple source nodes. In this example, each source node connected to the client system stores a different client specific filter for the client system, and multi-dimensional world state data is received from each source node that is filtered according to the client specific filter stored at the source nodes. In some implementations, the combination of the multi-dimensional world state data received from the two source nodes meets the world state data requests of the application running at the client system that implements the shared software application environment.

At block 1218, process 1202 can update stored entities using the received world state data. For example, the multi-dimensional world state data generated by the simulation servers and propagated by the mesh network can be defined relative to one or more shared software application environment entities, such as a user representation (e.g., avatar), virtual object (e.g., non-player entity), or other suitable entities of a shared software application environment. In some implementations, the entities may comprise a definition organized as an entity schema, such as a data structure that stores world state data about the entities such that the entities can be displayed, presented, and/or interacted with in the shared software application environment.

In some implementations, the client system can store local states for entities that support display of the entities in the shared software application environment. The client system can update the entity state stored in the entity data structure(s) to reflect the world state data received (e.g., serialize the received world state data to update local entity states). These updates support a coordinated display of the shared software application environment across several client systems. For example, the mesh network can propagate world state data to multiple client systems so that the displays of the entities at the multiple client systems (e.g., within the shared software application environment) reflect the changes in the world state propagated through the mesh network.

At block 1220, process 1202 can display the shared software application environment to a user based on the updated entities. For example, entities within the shared software application environment (e.g., user presence entities, such as avatars, virtual objects, etc.) can be displayed according to the updated world state data propagated to the client system.

At block 1222, process 1202 can transmit messages to one or more simulation servers via the mesh network that comprise user updates to world state data. For example, the client system can be an XR system, two-dimensional display system, three-dimensional display system, or any system capable of displaying the shared software application environment to a user. The user can provide input to the client system that represents actions within the shared software application environment (e.g., actions of the user's avatar). The client system can transmit messages that include world state updates for the user (e.g., user actions) to the mesh network (e.g., one or more source nodes connected to the client system) that are propagated back to the simulation server(s) such that the simulated dynamics for the shared software application environment account for the user's state updates. Other state updates from other client systems that represent other user actions can similarly be propagated, via the mesh network, back to the simulation server(s).

At block 1224, process 1204 can receive filtered world state data from source node(s). For example, world state data filtered according to one or more defined filters assigned to a simulation server can be received at the simulation server from one or more source nodes (e.g., server nodes and/or aggregation nodes). In some implementations, the filtered world state data is provided to the mesh network by other simulation servers that simulate dynamics for the shared software application environment. In some implementations, the world state data received at a simulation server includes user state updates provided to the mesh network by client systems (e.g., messages from the client systems).

At block 1226, process 1204 can update stored entities using the received world state data. For example, the multi-dimensional world state data provided by the simulation servers and/or client systems and propagated by the mesh network can be defined relative to one or more shared software application environment entities. In some implementations, the entities may comprise a definition organized as an entity schema, such as a data structure that stores world state data about the entities.

In some implementations, the simulation server(s) can store local states for entities that support simulating dynamics for the shared software application environment. The simulation server(s) can update the entity state stored in the entity data structure(s) to reflect the world state data received (e.g., serialize the received world state data to update local entity states). These updates support a coordinated implementation of the shared software application environment. For example, a simulation server is provided state updates from other simulation servers and from client systems so that the simulated dynamics for the shared software application environment performed at the simulation server account for state updates from each of these sources.

At block 1228, process 1204 can simulate shared software application environment dynamics. For example, using the updated world state data (e.g., entity state updates) received at the simulation server, dynamics for the shared software application environment can be simulated, such as interactions among users, virtual objects, and other suitable software application environment entities. The simulation of the software application environment dynamics can generate state updates for the software application environment entities.

At block 1230, process 1204 can transmit world state data based on the simulation to source nodes. For example, the world state data generated by the simulation of the software application environment dynamics can be transmitted to source nodes of the mesh network according to the assigned source node filters. In some implementations, the filtered world state data received by the source nodes at block 1206 can be transmitted by simulation server(s) after simulating dynamics for the shared software application environment and generating updated world state data.

FIG. 13 is a flow diagram illustrating a process used in some implementations of the present technology for managing nodes of the mesh network. In some implementations, process 1300 can be performed in response to initiation of a shared software application environment or during an ongoing shared software application environment. In some implementations, process 1300 can be performed by one or more fabric nodes of a mesh network and/or one or more node controllers of a mesh network. Examples of a shared software application environment include a two-dimensional software environment, a three-dimensional software environment, a XR environment, an immersive environment, any other suitable software environment, or any combination thereof.

At block 1302, process 1300 can monitor one or more load metrics on one or more server nodes. For example, a node controller can monitor a load on server nodes of the mesh network. Example monitored load metrics can include a number of client system connections for the server node(s), a volume of world state data received by/managed at the server node(s) (e.g., covered by a filter assigned to the server node(s)), a computing resource utilization metric (e.g., processors utilization, memory utilization, etc.), or any other suitable load metric.

At block 1304, process 1300 can determine whether the one or more load metrics meet a split criteria. Example split criteria include a threshold number of client connections, a threshold volume of world state data covered by the server node's assigned filter(s), computing resource utilization metric threshold(s), other suitable split criteria, or any combination thereof. For example, when a given server node comprises a threshold number of client connections and a processor utilization for a computing device that implements the server node meets or exceeds a processor utilization threshold, the load metrics on the given server node can meet the split criteria. When the monitored load metric(s) for a server node meet the split criteria, process 1300 can progress to block 1306. When the monitored load metric(s) for a server node fail to meet the split criteria, process 1300 can progress to block 1320.

At block 1306, process 1300 can select one or more server node filters for adjustment. For example, the monitored load metrics for a given server node can meet the load criteria, and the filter assigned to the given server node can be selected for adjustment. At block 1308, process 1300 can select a candidate filter property dimension for adjustment. For example, the selected server node filter can comprise several dimension properties. One or more of the dimension properties can be selected as a candidate dimension property for adjustment.

In some implementations, a predetermined selection policy can be defined for a shared software application environment, such as one or more predefined dimension property for selection when a server node (e.g., monitored load metrics for the server node) meets a split criteria. For example, software application environment location can be a defined as a first priority candidate filter property dimension selection. A second priority candidate filter property dimension selection (e.g., after looping back from block 1310) can be the real-world connection location for client system(s) (e.g., geographic location), an application specific filter property dimension (e.g., assigned group or class, or other suitable application specific dimension), or any other suitable filter property dimension.

At block 1310, process 1300 can determine whether adjustment of the candidate filter property dimension meets an adjustment criteria. For example, the node monitor can simulate adjustment of the selected candidate filter property, such as reducing the software application environment location coverage (e.g., XR environment volume) for the selected server node filter (e.g., reducing by a predefined volume, splitting the volume in half, etc.), reducing the real-world geographic region size for the selected server node filter (e.g., reducing by a predefined area, splitting the region in half, etc.), reducing a scope of the application specific filter property dimension for the selected server node filter, or any other suitable scope reduction for the selected server node filter.

Based on the simulated adjustment of the selected candidate filter property dimension, the node manager can estimate load metric(s) for the selected server node, such as the number of client connections, volume of world state data coverage, computing resource utilization metric(s), and any other suitable load metrics. When the simulated load metrics fall below one or more thresholds (e.g., a threshold number of client connections, a threshold volume of world state data covered by the reduced size filter, computing resource utilization metric threshold(s), other suitable thresholds, or any combination thereof), the adjustment of the candidate filter property dimension can meet the adjustment criteria.

When adjustment of the candidate filter property dimension meets the adjustment criteria, process 1300 can progress to block 1312. When adjustment of the candidate filter property dimension does not meet the adjustment criteria, process 1300 can loop back to block 1308, where a next candidate property dimension can be selected. For example, process 1300 can loop through a plurality of candidate property dimensions until adjustment of one of the candidate property dimensions meets the adjustment criteria.

At block 1312, process 1300 can perform the candidate filter property dimension adjustment that meets the adjustment criteria. For example, the candidate filter property dimension adjustment can be reducing the software application environment location coverage for the selected server node filter, reducing the real-world geographic region for the selected server node filter, reducing a scope of the application specific filter property dimension for the selected server node filter, or any other suitable scope reduction for the selected server node filter. In some implementations, the scope adjustment for the selected server node can be performed by one or more fabric nodes.

At block 1314, process 1300 can initiate a new server node. For example, a new server node can be provisioned by the node manager, the fabric node(s), or any other suitable mesh network system component. At block 1316, process 1300 can define one or more new server node filter(s). For example, a server node filter for the new server node can be defined (e.g., by one or more fabric nodes) to cover at least the scope reduction caused by the adjustment to the selected server node filter. For example, when the location coverage of the software application environment covered by the selected server node filter is reduced (e.g., at block 1312) the filter for the new server node can be defined to cover this reduction. In some implementations, the new server node filter can be defined to mirror the selected server node filter, however the software application environment location coverage initially covered by the selected server node filter can be split between the adjusted server node filter and the new server node filter (e.g., the selected server node filter can be adjusted to a first half the software application environment location coverage previously covered and the new server node filter can be defined to cover the second half of the software application environment location coverage previously covered). Any other suitable filter can be defined for the new server node.

In some implementations, after initiation of the new server node, world state data can be propagated to the new server node. For example, the propagated world state data can be a copy of the world state data covered by the filter(s) assigned to the selected server node (e.g., the server node selected to be split). In some implementations, the world state data can be propagated to the new server node after new server node filter(s) are defined for the new server node. In this example, the world state data propagated to the new server node can be a copy of the world state data covered by the filter(s) assigned to the selected server node (e.g., the server node selected to be split) after filtration by the filter(s) assigned to the new server node.

At block 1318, process 1300 can transition one or more client system connections to the new server node. For example, one or more client systems that are covered by the filter definition for the new server node can be transitioned from the selected server node to the new server node. In some implementations, the client systems can be instructed to transition by the selected server node, one or more fabric nodes, node controller, or any other suitable mesh network component.

At block 1320, process 1300 can determine whether one or more load metrics for multiple server nodes meet an aggregation criteria. Example aggregation criteria include a threshold number of client connections, a threshold volume of world state data covered by the server node's assigned filter, computing resource utilization metric threshold(s), any combination thereof, or other suitable aggregation criteria. For example, when a first server node comprises a threshold number of client connections and the processor utilization for a computing device that implements a second server node meets or exceeds a processor utilization threshold, the load metrics on the first and second server nodes can meet the aggregation criteria. In another example, when the first server node comprises a threshold number of client connections and the second server node comprises a threshold number of client connections, the load metrics on the first and second server nodes can meet the aggregation criteria.

When the monitored load metric(s) for multiple server nodes meet the aggregation criteria, process 1300 can progress to block 1322. When the load metric(s) for multiple server nodes fail to meet the aggregation criteria, process 1300 can loop back to block 1302, where the load metric(s) for the server nodes can continue to be monitored.

At block 1322, process 1300 can initiate a new aggregation node. For example, a new aggregation node can be provisioned that sources from the multiple server nodes with load metric(s) that met the aggregation criteria. At block 1324, process 1300 can select filter dimension properties for aggregation. For example, dimension properties for aggregation can be selected from the filters assigned to the first and second server nodes (e.g., the nodes with monitored metric(s) that met the aggregation criteria).

In some implementations, a predetermined selection policy can be defined for a shared software application environment, such as one or more dimension properties for use to define filter(s) for aggregation nodes. For example, software application environment location can be a default dimension property on which to aggregate. Additional predetermined filter property dimension selections for aggregation can include the real-world connection location for client systems (e.g., geographic location), an application specific filter property dimension (e.g., assigned group or class, or other suitable application specific dimension), or any other suitable filter property dimension.

At block 1326, process 1300 can define one or more new aggregation node filter(s). For example, a scope for the defined aggregation node filter can cover subset(s) of the coverage over the server node filters assigned to the first and second server nodes. In some implementations, the defined aggregation node filter can overlap the assigned filters for the first and second server nodes relative to the software application environment location dimension, real-world connection location for client systems, an application specific filter property dimension, or any other suitable filter property dimension.

At block 1328, process 1300 can transition one or more client system connections to the new server node. For example, one or more client systems that are covered by the filter definition for the new aggregation node can be transitioned from the selected server node to the new aggregation node. In some implementations, the client systems can be instructed to transition by the first server node or the second server node, one or more fabric nodes, node controller, or any other suitable mesh network component.

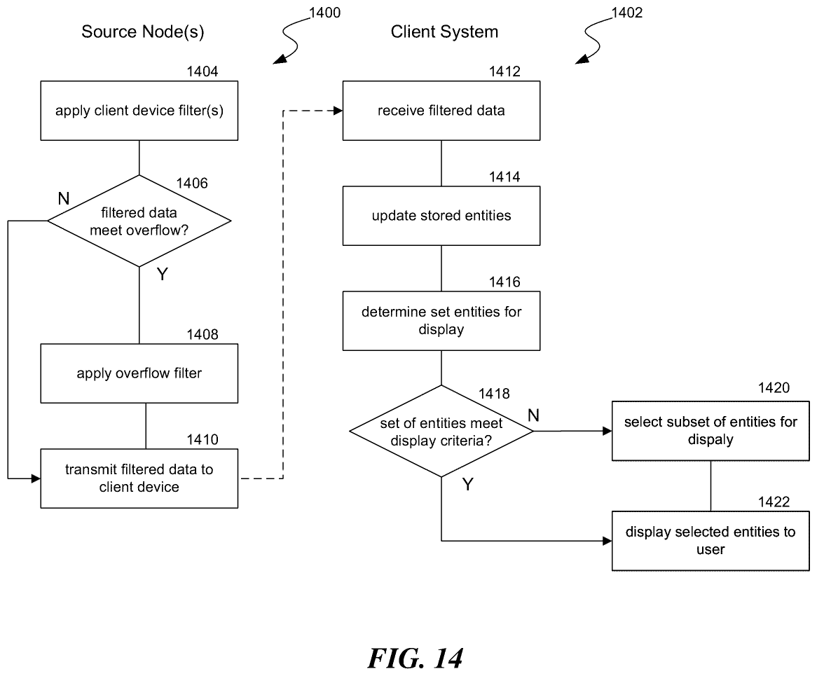

FIG. 14 is a flow diagram illustrating a process used in some implementations of the present technology for managing filtered data received and displayed at a client system. In some implementations, processes 1400 and 1402 can be performed in response to initiation of a shared software application environment or during an ongoing shared software application environment. In some implementations, process 1400 can be performed by source nodes of a mesh network (e.g., server nodes and/or aggregation nodes) and process 1402 can be performed by a client system. Examples of a shared software application environment include a two-dimensional software environment, a three-dimensional software environment, a XR environment, an immersive environment, any other suitable software environment, or any combination thereof.

At block 1404, process 1400 can apply client filters to multi-dimensional world state data received at a source node. For example, client filters can define a topology of multi-dimensional world state data, for example based on defined dimensions of the world state data and defined data values that bound these defined dimensions. In some implementations, a source node (e.g., server node or aggregation node) can apply a client specific filter (e.g., received from the client system) to world state data received at the source node. The application of the client specific filter can generate client specific filtered world state data.

At block 1406, process 1400 can determine whether the client filtered world state data meets an overflow criteria. For example, the client specific filtered world state data can comprise world state data for a set of entities that meet the client specific filter. Entities can be any suitable component of a shared software application environment, such as a user presence (e.g., avatar), virtual object, or other suitable entity. The number of entities within the client filtered world state data can be compared to an overflow criteria (e.g., threshold number of entities). When the number of entities meets or exceeds the threshold number of entities, it can be determined that the client filtered world state data meets the overflow criteria.

When the client filtered world state data meets the overflow criteria, process 1400 can progress to block 1408. When the client filtered world state data does not meet the overflow criteria, process 1400 can progress to block 1410. At block 1408, process 1400 can apply an overflow criteria to the client filtered world state data. For example, the client filtered world state data can be further filtered based on a predetermined dimension property for the defined client filter. In some implementations, a dimension property of a client filter selected for overflow filtering can be predetermined for a shared software application environment. The predetermined dimension property can be the software application environment location, the real-world connection location for client systems (e.g., geographic location), an application specific filter property dimension (e.g., assigned group or class, or other suitable application specific dimension), or any other suitable filter property dimension.

In some implementations, the predetermined dimension property can be reduced by a predetermined scope to apply the overflow criteria. For example, the client filter can comprise data values for the dimension property, and the data values (e.g., software application environment location coverage, such as XR environment volume) can be reduced by a predetermined scope to apply the overflow criteria. The reduced scope client filter can be applied to the client filtered world state data to reduce the number of entities. In some implementations, the scope for the predetermined dimension property can be iteratively reduced (e.g., by a predetermined step size) until the number of entities within the client filtered data meets the overflow criteria.

At block 1410, process 1400 can transmit the filtered world state data to the client system. For example, the client filtered world state data and/or overflow filtered world state data can be transmitted to the client system. In some implementations, the filtered world state data can be organized as a set of entities. The source node can transmit an indication that an overflow criteria was triggered for the client filtered world state data when the scope of the defined client filter produced a number of entities that met the overflow threshold.

At block 1412, process 1402 can receive the filtered world state data. For example, a client system can receive client filtered world state data from the source node of the mesh network. In some implementations, the client filtered world state data meets the world state data requests of an application running at the client system that implements the shared software application environment.

In some implementations, the client system is connected to multiple source nodes. In this example, each source node connected to the client system stores a different client specific filter for the client system, and multi-dimensional world state data is received from each source node that is filtered according to the client specific filter stored at the source nodes. In some implementations, the combination of the multi-dimensional world state data received from the two source nodes meets the world state data requests of the application running at the client system that implements the shared software application environment.

In some implementations, one or more of the source nodes that transmit client filtered world state data to the client system may apply an overflow criteria (e.g., additional filtering) to the client filtered data. In this example, an indication can be received from the source node that such an overflow criteria was applied to the client filtered world state data.

At block 1414, process 1402 can update stored entities using the world state data. For example, multi-dimensional world state data generated by simulation server(s) and propagated by the mesh network can be defined relative to one or more entities (e.g., a user representation, such as an avatar, virtual object, such as a non-player entity, or other suitable entities of a shared software application environment). In some implementations, the entities may comprise a definition organized as an entity schema, such as a data structure that stores world state data about the entities such that the entities can be displayed, presented, and/or interacted with in the shared software application environment.

In some implementations, the client system can store local states for entities that support display of the entities in the shared software application environment. The client system can update the entity state stored in the entity data structure(s) to reflect the world state data received (e.g., serialize the received world state data to update local entity states). These updates support a coordinated display of the shared software application environment across several client systems.

At block 1416, process 1402 can determine an initial set of entities for display to a user. For example, an initial set of entities can meet a display criteria relative to the user of the client system. The display criteria can include proximity to the user in the shared software application environment (e.g., a location for the entity meeting a distance criteria relative to a location for the user presence/avatar), a proximity to the user in a social graph (when the entity is another user), a size criteria (e.g., a threshold display size for the entity), any combination thereof, or any other suitable criteria that represents a relevance of the entity to the user.

At block 1418, process 1402 can determine whether the initial set of entities meets a display criteria. For example, the number of entities in the initial set can be compared to a display threshold, and when the number of entities meets or exceeds the display threshold the initial set is determined not to meet the display criteria. In another example where the shared software application environment comprises a shared XR environment, a percentage of the volume of the shared XR environment proximate to the user (e.g., within a predetermined distance from the user) occupied by displayed entities upon display of the initial set of entities can be compared to a density threshold, and when the displayed entities meet or exceeds the density threshold the initial set is determined not to meet the display criteria.

When the initial set of entities meets the display criteria, process 1402 can progress to block 1422. When the initial set of entities does not meet the display criteria, process 1402 can progress to block 1420. At block 1420, process 1402 can select a subset of entities for display to the user. For example, the initial set of entities can be filtered to generate the subset of entities according to one or more predetermined criteria. In some embodiments, the scope(s) of one or more display criteria can be reduced to perform the additional filtering. For example, the distance metric for the proximity to the user in the shared software application environment can be reduced, the social graph proximity criteria can be reduced in scope, the size criteria can be reduced, any combination thereof, or any other suitable scope reduction for the display criteria can be performed.

At block 1422, process 1402 can display the selected entities to the user. For example, the selected entities (e.g., initial set of entities or subset of entities) for the shared software application environment (e.g., user presence entities, such as avatars, virtual objects, etc.) can be displayed according to the world state data propagated to the client system. In some embodiments, the user can interact with the displayed entities via the client system (e.g., XR system).

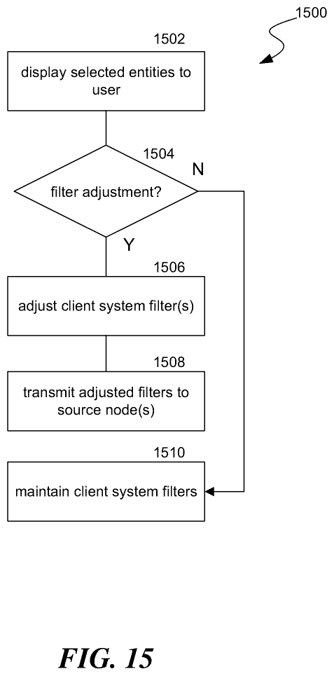

FIG. 15 is a flow diagram illustrating a process used in some implementations of the present technology for adjusting a scope of one or more client filters. In some implementations, process 1500 can be performed in response to initiation of a shared software application environment or during an ongoing shared software application environment. In some implementations, process 1500 can be performed by a client system, such as an XR system. Process 1500 can be a part of process 1402 of FIG. 14. For example, the flow of process 1500 can continue from block 1422 of FIG. 14. Examples of a shared software application environment include a two-dimensional software environment, a three-dimensional software environment, a XR environment, an immersive environment, any other suitable software environment, or any combination thereof.

At block 1502, process 1500 can display selected entities to the user. For example, selected entities for the shared software application environment (e.g., user presence entities, such as avatars, virtual objects, etc.) can be displayed to a user by a client system according to world state data propagated to the client system. For example, block 1502 of process 1500 can be similar to block 1422 of process 1400 from FIG. 14.

At block 1504, process 1500 can determine whether to perform an adjustment to one or more of the client filters. For example, one or more source nodes can transmit an indication to the client system that an overflow criteria was triggered at the source node when applying the client system's client filter. When an indication that an overflow criteria was triggered is received from at least one source, process 1500 can determine that one or more client filters should be adjusted. In another example, when the number of overflow trigger indications received from a given source node over a predefined period of time meets a threshold number, process 1500 can determine that one or more client filters should be adjusted.

When it is determined that an adjustment to one or more client filters should be performed, process 1500 can progress to block 1506. When it is determined that an adjustment to one or more client filters should not be performed, process 1500 can progress to block 1510, where existing client filters can be maintained. For example, multi-dimensional world state data can continue to be propagated from the mesh network to the client system using the existing client filters.

At block 1506, one or more client filters can be adjusted. For example, when overflow trigger indication(s) are received from a source node, the client specific filter defined for the source node can be adjusted by the client. In some implementations, a scope for the source node's client filter can be reduced. The scope reduction can be one or more of: a) reducing the software application environment location coverage of the client filter (e.g., reducing a XR environment volume covered by the client filter); b) reducing the social graph coverage (e.g., reducing a scope of a proximity metric) covered by the client filter; c) reducing dimension data values for an application specific dimension; d) any combination thereof; and/or e) any other suitable scope reduction.

At block 1508, the adjusted client filter(s) can be transmitted to one or more source nodes. For example, the client system can transmit the adjusted client filters to source node(s) that provided the triggered overflow criteria indication(s). In some implementations, multi-dimensional world state data can be propagated from the one or more source nodes to the client system using the adjusted client filters.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for selecting, from filtered world state data, entities to display to a user in an artificial reality (XR) environment, the method comprising:
receiving, at a client system from multiple source nodes, multi-dimensional world state data filtered according to a filter defined for the client system, wherein the client system displays an XR environment to a user, and the defined filter defines a topology of the multi-dimensional world state data relative to the user;
updating, at the client system, stored state data for a plurality of entities of the XR environment using the received multi-dimensional world state data;
determining, using the stored state data for the plurality of entities, an initial set of entities for display to the user;
selecting, in response to the initial set of entities meeting or exceeding a display criteria, a subset of the initial set of entities; and
displaying the selected subset of entities to the user in the XR environment.

2. The method of claim 1,
wherein the source nodes comprise one or more server nodes and/or one or more aggregation nodes,
wherein at least one server node receives multi-dimensional world state data from one or more simulation servers filtered according to a filter defined for the at least one server node, the filter for the at least one server node comprising scope overlap with the filter defined for the client system.

3. The method of claim 2, wherein at least one aggregation node receives multi-dimensional world state data from the one or more server nodes filtered according to a filter defined for the at least one aggregation node, the filter for the at least one aggregation node comprising scope overlap with the filter defined for the client system.

4. The method of claim 1, wherein the defined filter for the client system comprises dimension properties and dimension property values that filter the multi-dimensional world state data, such that the client system receives the topology of multi-dimensional world state data, bounded by the dimension property values defined in the filter.

5. The method of claim 4, wherein the dimension properties of the defined filter comprise one or more of XR environment instance identifier, XR world location, social graph metric, real-world connection location, or any combination thereof.

6. The method of claim 4,
wherein the defined filter for the client system comprises at least a first filter parameter and a second filter parameter,
wherein the first filter parameter defines first dimension properties and first dimension property values that filter the multi-dimensional world state data received by the client and the second filter parameter defines second dimension properties and second dimension property values that filter the multi-dimensional world state data received by the client, and
wherein the first filter parameter comprises a first refresh rate and the second parameter comprises a second refresh rate, such that updates of the first dimension of world state data filtered according to the first filter parameter are received by the client at the first refresh rate and updates of the world state data filtered according to the second filter parameter are received by the client at the second refresh rate, the first refresh rate being faster than the second refresh rate.

7. The method of claim 1,
wherein the two or more source nodes are configured to filter world state data received at the source nodes according to the filter, defined for the client system, to generate client filtered data and provide the client filtered data to the client system; and
wherein, after generating the client filtered data, at least one source node: A) filters the client filtered data according to an overflow filter in response to a number of entities within the client filtered data meeting or exceeding an overflow criteria, and B) provides the overflow filtered data to the client system, the overflow filter reducing the number of entities in the overflow filtered data to a threshold number.

8. The method of claim 7,
wherein the at least one source node is configured to transmit an indication to the client system when the overflow filter is triggered, and
wherein, after receiving the indication that the overflow filter was triggered, the client system reduces a scope of the filter defined for the client system.

9. The method of claim 1, further comprising:
reducing, when the initial set of entities meets or exceeds the display criteria, a scope for the filter defined for the client system.

10. A computer-readable storage medium storing instructions that, when executed by a computing system, cause the computing system to perform a process for selecting, from filtered world state data, entities to display to a user in an artificial reality (XR) environment, the process comprising:
receiving, at a client system from multiple source nodes, multi-dimensional world state data filtered according to a filter defined for the client system, wherein the client system displays an XR environment to a user, and the defined filter defines a topology of the multi-dimensional world state data relative to the user;
updating, at the client system, stored state data for a plurality of entities of the XR environment using the received multi-dimensional world state data;
determining, using the stored state data for the plurality of entities, an initial set of entities for display to the user;
selecting, in response to the initial set of entities meeting or exceeding a display criteria, a subset of the initial set of entities; and
displaying the selected subset of entities to the user in the XR environment.

11. The computer-readable storage medium of claim 10,
wherein the source nodes comprise one or more server nodes and/or one or more aggregation nodes,
wherein at least one server node receives multi-dimensional world state data from one or more simulation servers filtered according to a filter defined for the at least one server node, the filter for the at least one server node comprising scope overlap with the filter defined for the client system.

12. The computer-readable storage medium of claim 11, wherein at least one aggregation node receives multi-dimensional world state data from the one or more server nodes filtered according to a filter defined for the at least one aggregation node, the filter for the at least one aggregation node comprising scope overlap with the filter defined for the client system.

13. The computer-readable storage medium of claim 10, wherein the defined filter for the client system comprises dimension properties and dimension property values that filter the multi-dimensional world state data such that the client system receives the topology of multi-dimensional world state data bounded by the dimension property values defined in the filter.

14. The computer-readable storage medium of claim 13, wherein the dimension properties of the defined filter comprise one or more of XR environment instance identifier, XR world location, social graph metric, real-world connection location, or any combination thereof.

15. The computer-readable storage medium of claim 13,
wherein the defined filter for the client system comprises at least a first filter parameter and a second filter parameter,
wherein the first filter parameter defines first dimension properties and first dimension property values that filter the multi-dimensional world state data received by the client and the second filter parameter defines second dimension properties and second dimension property values that filter the multi-dimensional world state data received by the client, and
wherein the first filter parameter comprises a first refresh rate and the second parameter comprises a second refresh rate, such that updates of the first dimension of world state data filtered according to the first filter parameter are received by the client at the first refresh rate and updates of the world state data filtered according to the second filter parameter are received by the client at the second refresh rate, the first refresh rate being faster than the second refresh rate.

16. The computer-readable storage medium of claim 10,
wherein the two or more source nodes are configured to filter world state data received at the source nodes according to the filter, defined for the client system, to generate client filtered data and provide the client filtered data to the client system; and
wherein, after generating the client filtered data, at least one source node: A) filters the client filtered data according to an overflow filter in response to a number of entities within the client filtered data meeting or exceeding an overflow criteria, and B) provides the overflow filtered data to the client system, the overflow filter reducing the number of entities in the overflow filtered data to a threshold number.

17. The computer-readable storage medium of claim 16,
wherein the at least one source node is configured to transmit an indication to the client system when the overflow filter is triggered, and
wherein, after receiving the indication that the overflow filter was triggered, the client system reduces a scope of the filter defined for the client system.

18. The computer-readable storage medium of claim 1, wherein the process further comprises:
reducing, when the initial set of entities meets or exceeds the display criteria, a scope for the filter defined for the client system.

19. A computing system for selecting, from filtered world state data, entities to display to a user in an artificial reality (XR) environment, the computing system comprising:
one or more processors; and
one or more memories storing instructions that, when executed by the one or more processors, cause the computing system to perform a process comprising:
receiving, at a client system from multiple source nodes, multi-dimensional world state data filtered according to a filter defined for the client system, wherein the client system displays an XR environment to a user, and the defined filter defines a topology of the multi-dimensional world state data relative to the user;
updating, at the client system, stored state data for a plurality of entities of the XR environment using the received multi-dimensional world state data;
determining, using the stored state data for the plurality of entities, an initial set of entities for display to the user;
selecting, in response to the initial set of entities meeting or exceeding a display criteria, a subset of the initial set of entities; and
displaying the selected subset of entities to the user in the XR environment.

20. The system of claim 19,
wherein the source nodes comprise one or more server nodes and/or one or more aggregation nodes,
wherein at least one server node receives multi-dimensional world state data from one or more simulation servers filtered according to a filter defined for the at least one server node, the filter for the at least one server node comprising scope overlap with the filter defined for the client system.
